(19) United States
(12) Patent Application Publication
(10) Pub. No.: US 2023/0353460 A1
(43) Pub. Date: Nov. 2, 2023

(54) USER EQUIPMENT, BASE STATION AND METHOD PERFORMED BY THE SAME

(71) Applicant: SAMSUNG ELECTRONICS CO., LTD., Suwon-si (KR)

(72) Inventors: Liying ZHOU, Beijing (CN); Feifei SUN, Beijing (CN); He WANG, Beijing (CN); Zhe CHEN, Beijing (CN); Yiyan ZHANG, Beijing (CN)

(21) Appl. No.: 18/322,186

(22) Filed: May 23, 2023

Related U.S. Application Data
(63) Continuation of application No. PCT/KR2023/005514, filed on Apr. 21, 2023.

(30) Foreign Application Priority Data
Apr. 27, 2022 (CN) 202210459389.0
Mar. 13, 2023 (CN) 202310260780.2

(51) Int. Cl. H04L 41/16

(52) U.S. Cl. CPC H04L 41/16

(57) ABSTRACT

An example method performed by a user equipment (UE) comprises receiving, from a base station, switching indication information for switching from a source processing approach to a target processing approach, wherein the source processing approach or the target processing approach are related to an artificial intelligence (AI) model. The method comprises applying the target processing approach from a second time. The second time is identified based on at least one of features of the target processing approach, features of the source processing approach, or a first time. The first time is a time in which the switching indication information is received.

### CROSS-REFERENCE TO RELATED APPLICATIONS

This application is a continuation of International Application No. PCT/KR2023/005514, designating the United States, filed Apr. 21, 2023, in the Korean Intellectual Property Receiving Office and claiming priority to Chinese Patent Application No. 202210459389.0 filed on Apr. 27, 2022, in the Chinese Patent Office and to Chinese Patent Application No. 202310260780.2 filed on Mar. 13, 2023, in the Chinese Patent Office. The entire disclosures of each of these applications are incorporated herein by reference for all purposes.

### BACKGROUND

### Field

The disclosure relates to the field of wireless communication technology, and specifically, relates to a transmission method and equipment of an artificial intelligence (AI) model in a wireless communication system, and a method and equipment for switching a processing approach related to the AI model.

### Description of Related Art

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

The present disclosure provides a transmission method and equipment of an artificial intelligence (AI) model in a wireless communication system, and a method and equipment for switching a processing approach related to the AI model so as to at least solve issues in the related technology.

According to an example embodiment, a transmission method of an artificial intelligence (AI) model may include transmitting, by a model transmitter, first information related to AI model transmission to a model receiver and/or receiving second information related to AI model transmission from the model receiver; transmitting, by the model transmitter, at least one AI model to the model receiver; receiving, by the model transmitter, feedback regarding the at least one AI model from the model receiver.

In an example embodiment, the transmitting, by the model transmitter, of the first information related to the AI model transmission to the model receiver may include transmitting, by the model transmitter, a model attribute to the model receiver; and/or the receiving, by the model transmitter, of the second information related to the AI model transmission from the model receiver may include receiving, by the model transmitter, an inherent AI capability and/or a model support capability of the model receiver, from the model receiver.

In an embodiment, the at least one AI model is indicated in the model attribute by the model transmitter.

In an embodiment, the at least one AI model is selected by the model transmitter according to at least one of the following information: the inherent AI capability of the model receiver, the model support capability of the model receiver, a model execution result of the model receiver, or the model transmitter's own demands.

In an embodiment, the model transmitter is a base station, and the model receiver is a user equipment, wherein the model attribute and/or the at least one AI model are/is transmitted from the model transmitter to the model receiver by a transmission scheme in a unicast scheme, a multicast scheme and/or a broadcast scheme; and/or the inherent AI capability and/or the model support capability are/is transmitted from the model receiver to the model transmitter by a unicast scheme.

In an embodiment, the model transmitter is a user equipment, and the model receiver is a base station, wherein the model attribute and/or the at least one AI model are/is transmitted from the model transmitter to the model receiver by a unicast scheme; and/or the inherent AI capability is transmitted from the model receiver to the model transmitter by a transmission scheme in a unicast scheme, a multicast scheme and/or a broadcast scheme; and/or the model support capability is transmitted from the model receiver to the model transmitter by a unicast scheme.

In an embodiment, if the model transmitter determines that all the AI models indicated by the model attribute transmitted by the model transmitter to the model receiver are not suitable for the model receiver according to the inherent AI capability and/or the model support capability, the model transmitter receives new first information related to AI model transmission from the model receiver and/or transmits new second information related to AI model transmission to the model receiver; and/or, if the model transmitter determines that the at least one AI model is not suitable for the model receiver according to the feedback, the model transmitter receives new first information related to AI model transmission from the model receiver and/or transmits new second information related to AI model transmission to the model receiver, transmits at least one other AI model to the model receiver, and receives feedback regarding the at least one other AI model from the model receiver.

In an embodiment, the model support capability indicates AI models that the model receiver may support among the AI models indicated by the model attribute transmitted by the model transmitter to the model receiver, and/or indicates AI models already possessed by the model receiver among the AI models indicated by the model attribute.

In an embodiment, the model attribute includes at least one of the following information: model complexity, model input and/or output, model application range, model transmission scheme and/or time-frequency resource indication, wherein the time-frequency resource indication is used to identify a time-frequency resource for transmitting models; and wherein the model application range includes a model applicable cell range and/or a model applicable SNR range, and the model applicable cell range is indicated by a neighbor cell list and/or cross-cell model ID identification.

In an embodiment, the inherent AI capability includes at least one of following information: a computing capability level, a module(s) and/or functionality(s) that support(s) receiving and deploying AI models to implement a corresponding communication task, the maximum number of AI models that may be supported for simultaneous deployment by each of the module(s) and/or functionality(s), an upper limit for a size of a single AI model that may be supported, an upper limit for an overall size of AI models that are deployed simultaneously, whether to support receiving auxiliary models, or whether to support feedback of raw data.

In an embodiment, the receiving, by the model transmitter, of the feedback regarding the at least one AI model from the model receiver includes: receiving, by the model transmitter from the model receiver, feedback regarding whether the at least one AI model is executed correctly and/or execution efficiency of the at least one AI model.

According to an example embodiment, a reception method of an artificial intelligence (AI) model may include receiving, by a model receiver, first information related to AI model transmission from a model transmitter and/or transmitting second information related to AI model transmission to the model transmitter; receiving, by the model receiver, at least one AI model from the model transmitter; transmitting, by the model receiver, feedback regarding the at least one AI model to the model transmitter.

In an embodiment, the receiving, by the model receiver, of the first information related to the AI model transmission from the model transmitter includes receiving, by the model receiver, a model attribute from the model transmitter; and/or the transmitting, by the model receiver, of the second information related to the AI model transmission to the model transmitter includes transmitting, by the model receiver, an inherent AI capability and/or a model support capability of the model receiver, to the model transmitter.

In an embodiment, the at least one AI model is indicated in the model attribute by the model transmitter.

In an embodiment, the at least one AI model is selected by the model transmitter according to at least one of following information: the inherent AI capability of the model receiver, the model support capability of the model receiver, a model execution result of the model receiver, or the model transmitter's own demands.

In an embodiment, the model transmitter is a base station, and the model receiver is a user equipment, wherein the model attribute and/or the at least one AI model are/is transmitted from the model transmitter to the model receiver by a transmission scheme in a unicast scheme, a multicast scheme and/or a broadcast scheme; and/or the inherent AI capability and/or the model support capability are/is transmitted from the model receiver to the model transmitter by a unicast scheme.

In an embodiment, the model transmitter is a user equipment, and the model receiver is a base station, wherein the model attribute and/or the at least one AI model are/is transmitted from the model transmitter to the model receiver by a unicast scheme; and/or the inherent AI capability is transmitted from the model receiver to the model transmitter by a transmission scheme in a unicast scheme, a multicast scheme and/or a broadcast scheme; and/or the model support capability is transmitted from the model receiver to the model transmitter by a unicast scheme.

In an embodiment, if the model transmitter determines that all the AI models indicated by the model attribute received by the model receiver from the model transmitter are not suitable for the model receiver according to the inherent AI capability and/or the model support capability, the model receiver receives new first information related to AI model transmission from the model transmitter and/or transmits new second information related to AI model transmission to the model transmitter; and/or, if the model transmitter determines that the at least one AI model is not suitable for the model receiver according to the feedback, the model receiver receives new first information related to AI model transmission from the model transmitter and/or transmits new second information related to AI model transmission to the model transmitter, receives at least one other AI model from the model transmitter, and transmits feedback regarding the at least one other AI model to the model transmitter.

In an embodiment, the model support capability indicates AI models that the model receiver may support among the AI models indicated by the model attribute received by the model receiver from the model transmitter and/or indicates AI models already possessed by the model receiver among the AI models indicated by the model attribute.

In an embodiment, the model attribute includes at least one of following information: model complexity, model input and/or output, model application range, model transmission scheme and/or time-frequency resource indication, wherein the time-frequency resource indication is used to identify a time-frequency resource for transmitting models; and wherein the model application range includes a model applicable cell range and/or a model applicable SNR range, and the model applicable cell range is indicated by a neighbor cell list and/or cross-cell model ID identification.

In an embodiment, the inherent AI capability includes at least one of following information: a computing capability level, a module(s) and/or functionality(s) that support(s) receiving and deploying AI models to implement a corresponding communication task, the maximum number of AI models that may be supported for simultaneous deployment by each of the module(s) and/or functionality(s), an upper limit for a size of a single AI model that may be supported, an upper limit for an overall size of AI models that are deployed simultaneously, whether to support receiving auxiliary models, or whether to support feedback of raw data.

In an embodiment, the transmitting, by the model receiver, of the feedback regarding the at least one AI model to the model transmitter includes transmitting, by the model receiver to the model transmitter, feedback regarding whether the at least one AI model is executed correctly and/or execution efficiency of the at least one AI model.

In an example embodiment, a model transmitter apparatus may include a transceiver; and at least one processor coupled to the transceiver and configured to execute the above transmission method(s).

According to an example embodiment, a model receiver apparatus may include a transceiver; and at least one processor coupled to the transceiver and configured to execute the above reception method(s).

According to an embodiment, a method performed by a user equipment (UE) may include receiving, from a base station, switching indication information of a processing approach, wherein the processing approach is related to an artificial intelligence (AI) model, a time for receiving the switching indication information is a first time; applying a target processing approach from a second time, wherein the second time is related to at least one of following items: features of the target processing approach, features of a source processing approach, or the first time.

In an embodiment, the features of the target processing approach and/or the source processing approach include at least one of following items: a size of an AI model(s) related to the target processing approach and/or a size of an AI model(s) related to the source processing approach; the number of the AI model(s) related to the target processing approach and/or the number of the AI model(s) related to the source processing approach; whether the target processing approach belongs to a first set; whether the source processing approach belongs to a second set; a structure(s) of the AI model(s) related to the target processing approach and/or a structure(s) of the AI model(s) related to the source processing approach; a position(s) of the target processing approach and/or the source processing approach in a first switching sequence; or the number of a functionality(s) related to the target processing approach and/or the number of a functionality(s) related to the source processing approach.

In an embodiment, the first set and/or the second set are/is indicated by a base station or preset.

In an embodiment, the first switching sequence is associated with at least one of following items: a switching sequence indicated by a base station; a switching sequence reported by the UE; or a preset switching sequence.

In an embodiment, the method further includes deactivating the source processing approach at a third time when a first condition is satisfied, wherein the third time is before the second time.

In an embodiment, the method further includes applying a first processing approach between the third time and the second time.

In an embodiment, the first condition includes at least one of following items: a size of an AI model(s) related to the source processing approach is not less than a first threshold and/or a size of an AI model(s) related to the target processing approach is not less than a second threshold; a sum of the size of the AI model(s) related to the source processing approach and/or the size of the AI model(s) related to the target processing approach is not less than a third threshold; a processing source of the UE already occupied at the first time is not less than a fourth threshold and/or the size of the AI model(s) related to the target processing approach is not less than a fifth threshold; the structure(s) of the AI model(s) related to the source processing approach is same as the structure(s) of the AI model(s) related to the target processing approach; a related performance parameter value of the source processing approach is not greater than a sixth threshold; or a difference value between the second time and the first time is not less than a seventh threshold.

In an embodiment, the first processing approach is indicated by a base station or preset.

In an embodiment, the third time is related to at least one of following items: features of the first processing approach, the features of the source processing approach, or the first time.

In an embodiment, the features of the first processing approach include at least one of following items: a size of an AI model(s) related to the first processing approach; the number of the AI model(s) related to the first processing approach; whether the first processing approach belongs to a first set; a structure(s) of the AI model(s) related to the first processing approach; a position of the first processing approach in a first switching sequence; or the number of a functionality(s) related to the first processing approach.

In an embodiment, the method further includes determining the target processing approach related to multiple functionalities, wherein the target processing approach is a combination of processing approaches of the multiple functionalities, wherein the target processing approach is related to at least one of following items: the switching indication information, or the first switching sequence.

In an embodiment, the method further includes, when the target processing approach is the combination of the processing approaches of the multiple functionalities, and a second condition is satisfied, starting to apply the processing approach of each functionality among the target processing approaches related to the multiple functionalities simultaneously from the second time, wherein the second time is related to at least one of a switching delay, a first delay or an interruption time required when the multiple functionalities switch respectively. A switching delay required when each functionality switches separately represents a time difference between a time at which the functionality applies the corresponding target processing approach and the first time, in other words, the switching delay required when each functionality switches separately represents how long after the first time the functionality starts to apply the corresponding target processing approach; the first delay required when each functionality switches represents a time difference between a time at which the functionality deactivates the corresponding source processing approach and the first time, in other words, the first delay required when each functionality switches separately represents how long after the first time the functionality deactivates the corresponding source processing approach; the interruption time required when each functionality switches represents a time difference between a time at which the functionality applies the corresponding target processing approach and a time at which the functionality deactivates the corresponding source processing approach, in other words, the interruption time required when each functionality switches separately represents how long after the time at which the functionality deactivates the corresponding source processing approach the functionality starts to apply the corresponding target processing approach.

In an embodiment, the method further includes, when the target processing approach is the combination of the processing approaches of the multiple functionalities, and a third condition is satisfied, starting to deactivate the source processing approaches of the multiple functionalities simultaneously at the third time, wherein the third time is related to a first delay required when the multiple functionalities switch respectively.

In an embodiment, the first switching sequence includes different processing approaches of one functionality, each element in the first switching sequence includes one processing approach of the functionality, and in the first switching sequence, an AI model-based processing approach is represented by a model ID of an AI model, a model ID combination or a configuration ID, and a non-AI processing approach is represented by an empty set or a configuration ID of a non-AI approach.

In an embodiment, the first switching sequence includes different processing approaches of multiple functionalities, each element in the first switching sequence includes a combination of the processing approaches of the multiple functionalities, and, in the first switching sequence, an AI model-based processing approach is represented by a model ID of an AI model, a model ID combination or a configuration ID, and a non-AI processing approach is represented by an empty set or a configuration ID of a non-AI approach.

In an embodiment, each element in the first switching sequence further includes a switching condition related to the processing approach indicated by the element.

In an embodiment, a sorted order of the elements in the first switching sequence is determined based on at least one of following items: an order indicated by a base station; a preset order; or features of a processing approach.

In an embodiment, the features of the processing approach includes at least one of following items: a size of an AI model(s) related to the processing approach; the number of the AI model(s) related to the processing approach; a complexity of the AI model(s) related to the processing approach; or an applicable condition of the processing approach, wherein the applicable condition of the processing approach includes at least one of following items: a cell range, a Signal to Noise Ratio (SNR) range, a moving speed, a Doppler spread range, or a delay spread range.

In an embodiment, the determining of the target processing approaches related to the multiple functionalities includes, when the switching indication information is related to a position number of an element in the first switching sequence, determining the target processing approaches related to the multiple functionalities according to the corresponding element in the first switching sequence; and when the switching indication information only includes a first target processing approach related to a first functionality, determining a second target processing approach related to a second functionality according to the first target processing approach and the first switching sequence.

In an embodiment, the determining of the second target processing approach related to the second functionality according to the first target processing approach and the first switching sequence includes at least one of following items: when the element containing both of the processing approach of the second functionality at the first time and the first target processing approach does not exist in the first switching sequence, the second target processing approach is a corresponding processing approach of the second functionality indicated by a first element containing the first target processing approach in the first switching sequence; or when a fourth condition is satisfied, the second target processing approach is a second processing approach, wherein the second processing approach is a processing approach of the second functionality indicated by signaling for the last time, and wherein the fourth condition is that an element containing both of the second processing approach and the first target processing approach exists in the first switching sequence.

In an embodiment, a position(s) of the target processing approach and/or the source processing approach in the first switching sequence satisfy/satisfies at least one of following items: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy switching conditions and are adjacent to the source processing approach in the first switching sequence; the target processing approach is one of first N5 processing approaches in the first switching sequence; the target processing approach is one of first N6 processing approaches that satisfy switching conditions in the first switching sequence; or the target processing approach is one of N7 processing approaches selected to be reported by the UE from the first switching sequence, wherein at least one of N1 to N7 is preset, or is a number related to the size of the AI model.

According to an example embodiment, a method performed by a base station may include transmitting switching indication information of a processing approach to a UE, wherein the processing approach is related to an AI model, a time at which the UE receives the switching indication information is a first time, wherein the UE starts to apply a target processing approach from a second time, and wherein the second time is related to at least one of following items: features of the target processing approach, features of a source processing approach, or the first time.

In an embodiment, the features of the target processing approach and/or the source processing approach include at least one of following items: a size of an AI model(s) related to the target processing approach and/or a size of an AI model(s) related to the source processing approach; the number of the AI model(s) related to the target processing approach and/or the number of the AI model(s) related to the source processing approach; whether the target processing approach belongs to a first set; whether the source processing approach belongs to a second set; a structure(s) of the AI model(s) related to the target processing approach and/or a structure(s) of the AI model(s) related to the source processing approach; a position(s) of the target processing approach and/or the source processing approach in a first switching sequence; or the number of a functionality(s) related to the target processing approach and/or the number of a functionality(s) related to the source processing approach.

In an embodiment, the first set and/or the second set are/is indicated by a base station or preset.

In an embodiment, the method further includes indicating a switching sequence to the UE; and receiving a reported switching sequence from the UE.

In an embodiment, the first switching sequence is associated with at least one of following items: a switching sequence indicated by the base station; a switching sequence reported by the UE; or a preset switching sequence.

In an embodiment, the method further includes indicating a first processing approach to the UE, wherein when a first condition is satisfied, the UE deactivates the source processing approach at a third time, and applies the first processing approach between the third time and the second time.

In an embodiment, the first condition includes at least one of following items: a size of an AI model(s) related to the source processing approach is not less than a first threshold and/or a size of an AI model(s) related to the target processing approach is not less than a second threshold; a sum of the size of the AI model(s) related to the source processing approach and/or the size of the AI model(s) related to the target processing approach is not less than a third threshold; a processing source of the UE already occupied at the first time is not less than a fourth threshold and/or the size of the AI model(s) related to the target processing approach is not less than a fifth threshold; the structure(s) of the AI model(s) related to the source processing approach is same as the structure(s) of the AI model(s) related to the target processing approach; a related performance parameter value of the source processing approach is not greater than a sixth threshold; or a difference value between the second time and the first time is not less than a seventh threshold.

In an embodiment, the third time is related to at least one of following items: features of the first processing approach, the features of the source processing approach, or the first time.

In an embodiment, the features of the first processing approach include at least one of following items: a size of an AI model(s) related to the first processing approach; the number of the AI model(s) related to the first processing approach; whether the first processing approach belongs to a first set; a structure(s) of the AI model(s) related to the first processing approach; a position of the first processing approach in a first switching sequence; or the number of a functionality(s) related to the first processing approach.

In an embodiment, the first switching sequence includes different processing approaches of one functionality, each element in the first switching sequence includes a processing approach of the functionality, and, in the first switching sequence, an AI model-based processing approach is represented by a model ID of an AI model, a model ID combination or a configuration ID, and a non-AI processing approach is represented by an empty set or a configuration ID of a non-AI approach.

In an embodiment, the first switching sequence includes different processing approaches of multiple functionalities, each element in the first switching sequence includes a combination of the processing approaches of the multiple functionalities, and, in the first switching sequence, an AI model-based processing approach is represented by a model ID of an AI model, a model ID combination or a configuration ID, and a non-AI processing approach is represented by an empty set or a configuration ID of a non-AI approach.

In an embodiment, each element in the first switching sequence further includes a switching condition related to the processing approach indicated by the element.

In an embodiment, a sorted order of the elements in the first switching sequence is decided by at least one of following items: an order indicated by a base station; a preset order; or features of a processing approach.

In an embodiment, the features of the processing approach include at least one of following items: a size of an AI model(s) related to the processing approach; the number of the AI model(s) related to the processing approach; a complexity of the AI model(s) related to the processing approach; or an applicable condition of the processing approach, wherein the applicable condition of the processing approach includes at least one of following items: a cell range, an SNR range, a moving speed, a Doppler spread range, or a delay spread range.

In an embodiment, a position(s) of the target processing approach and/or the source processing approach in the first switching sequence satisfy/satisfies at least one of following items: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy switching conditions and are adjacent to the source processing approach in the first switching sequence; the target processing approach is one of first N5 processing approaches in the first switching sequence; the target processing approach is one of first N6 processing approaches that satisfy switching conditions in the first switching sequence; or the target processing approach is one of N7 processing approaches selected to be reported by the UE from the first switching sequence, wherein at least one of N1 to N7 is preset, or is the number related to the size of the AI model.

According to an example embodiment, a user equipment may include a transceiver; and at least one processor coupled to the transceiver and configured to execute the above method(s) executed by the UE.

According to an example embodiment, a base station may include a transceiver; and at least one processor coupled to the transceiver and configured to execute the method(s) executed by the base station.

According to an example embodiment, an electronic apparatus may include at least one processor; and at least one memory storing computer executable instructions, wherein the computer executable instructions, when executed by the at least one processor, cause the at least one processor to execute any one of the above-described method(s).

According to an example embodiment, a computer readable storage medium storing instructions may include instructions which, when executed by at least one processor, cause at least one processor to execute any one of the above-described method(s).

The AI transmission and reception solutions provided by the example embodiments of the present disclosure provide advantageous effects including, but not limited to: by transmitting the model attribute and the specific AI model (i.e., the model itself) separately, it is conducive to preliminarily screening applicable models between the BS and the UE, and reducing the overhead for transferring the model itself, that is, it can not only reduce the resource overhead, but also reduce the power consumption overhead; in addition, by the model transmitter indicating the model attribute to the model receiver and the model receiver expressing its AI capability (i.e., the inherent AI capability and/or model support capability) to the model transmitter, it is capable of pre-determining which models the model receiver supports, which models are more suitable for transmission in the current situation, which models are not necessarily transferred; in this way, the models that need to be transferred are screened out, and this can not only reduce the overhead for transmitting models, but also shorten the preparation process for using the AI model (in other words, shortening the preparation time before enabling the AI model); also, in a case in which the model transmitter is the BS, by such the model screening and the acquisition of the experience data (e.g., the feedback for the use of the models and the long-term, inherent AI capabilities of most UEs), the BS may select the more suitable transmission mode (broadcast/unicast/multicast) to transmit the models to further reduce the overhead for transmitting the models; in addition, after the model transfer, the model receiver gives feedback on the actual model execution status to the model transmitter so as to ensure the subsequent normal use of the models and achieve the expected execution.

The switching solutions of the processing approaches related to the AI model provided by the example embodiments of the present disclosure bring advantageous effects including, but not limited to: it is capable of reducing the switching delay effectively by applying the target processing approach at the second time; a fast switching within the interruption time may be realized by applying the first processing approach (i.e., a fallback scheme) between the third time and the second time (i.e., the interruption time); the UE may prepare the AI model in advance according to the information provided by the first switching sequence to thereby reduce the switching delay, and the UE may avoid the AI collision/compatibility issue according to the information provided by the first switching sequence; in addition, the UE may update the first switching sequence by reporting the switching sequence so as to avoid the AI collision or compatibility issue; when there are multiple functionalities that adopt or may adopt the AI-based processing approaches in the UE, it is capable of avoiding the AI collision and/or compatibility issue(s) by linkage switching, and, when the second functionality among multiple functionalities is downgraded in linkage, since the higher priority functionality occupies the AI processing resources, the second functionality can fast return to the preferred processing approach from the linkage downgrading.

According to embodiments, a method performed by a user equipment (UE) comprises receiving, from a base station, switching indication information for switching from a source processing approach to a target processing approach, wherein the source processing approach or the target processing approach are related to an artificial intelligence (AI) model. The method comprises applying the target processing approach from a second time. The second time is identified based on at least one of features of the target processing approach, features of the source processing approach, or a first time. The first time is a time in which the switching indication information is received.

According to embodiments, a user equipment (UE) comprises a transceiver. The UE comprises a processor coupled to the transceiver. The processor is configured to receive, from a base station, switching indication information for switching from a source processing approach to a target processing approach, wherein the source processing approach or the target processing approach are related to an artificial intelligence (AI) model. The processor is configured to apply the target processing approach from a second time, wherein the second time is identified based on at least one of features of the target processing approach, features of the source processing approach, or the first time. wherein a first time is a time in which the switching indication information is received.

According to embodiments, a method performed by a base station, comprises transmitting, to a UE, switching indication information for switching from a source processing approach to a target processing approach, wherein the source processing approach or the target processing approach are related to an AI model. The target processing approach is applied by the UE from a second time. A first time is a time in which the switching indication information is received. The second time is related to at least one of features of the target processing approach, features of the source processing approach, or the first time.

It should be understood that the above general description and the following detailed description are merely examples and illustrative without limiting the present disclosure.

### BRIEF DESCRIPTION OF DRAWINGS

The drawings here are incorporated into the description and constitute a part of the description, illustrate example embodiments conforming to the present disclosure, explain a principle of the present disclosure together with the description, and do not constitute inappropriate definition for the present disclosure.

The above and/or other aspects of the disclosure will be more apparent by describing certain embodiments of the disclosure with reference to the accompanying drawings, in which:

FIG. 1 illustrates an example wireless network 100 according to various embodiments;

FIGS. 2A and 2B illustrate an example wireless transmission path and an example wireless reception path according to various embodiments;

FIG. 3A illustrates an example user equipment 116 according to various embodiments;

FIG. 3B illustrates an example gNB 102 according to various embodiments;

FIG. 4 illustrates a deployment of models of AI-based CSI feedback;

FIG. 5 is a flowchart of an example transmission method of an AI model according to various embodiments;

FIG. 6 illustrates an example of a model attribute indication structure according to various embodiments;

FIG. 7 illustrates relationships between models/model sets according to various embodiments;

FIG. 8 is a flowchart of an example reception method of an AI model according to various embodiments;

FIG. 9 is a flowchart illustrating an example of transmitting a model by a BS to a UE according to various embodiments;

FIG. 10 is a flowchart illustrating an example of transmitting a model by a BS to a UE according to various embodiments;

FIG. 11 is a flowchart illustrating an example of transmitting a model by a BS to a UE according to various embodiments;

FIG. 12 is a flowchart illustrating an example of transmitting a model by a BS to a UE according to various embodiments;

FIG. 13 is a flowchart illustrating an example of transmitting a model by a UE to a BS according to various embodiments;

FIG. 14A is a diagram illustrating a timeline for model switching in a conventional art.

FIG. 14B is a diagram illustrating a potential collision of AI models during a switching process;

FIG. 15 is a flowchart illustrating an example method performed by a UE according to various embodiments;

FIG. 16A is a diagram illustrating an example timeline for processing approach switching according to various embodiments;

FIG. 16B is a diagram illustrating an example first processing approach (i.e., a fast fallback scheme) for interruption time according to various embodiments;

FIG. 16C is a diagram illustrating an example first processing approach (i.e., a fast fallback scheme) applied for interruption time according to various embodiments;

FIG. 16D is a diagram illustrating an example switching sequence according to various embodiments;

FIG. 17 is a diagram illustrating an example of switching a processing approach according to various embodiments;

FIG. 18 is a diagram illustrating an example of sorting AI models according to various embodiments;

FIG. 19 is a diagram illustrating an example switching sequence according to various embodiments;

FIG. 20 is a diagram illustrating an example timeline of switching processing approaches for multiple functionalities according to various embodiments;

FIG. 21 is a diagram illustrating an example timeline of switching processing approaches for multiple functionalities according to various embodiments;

FIG. 22 is a flowchart illustrating an example method performed by an example base station according to various embodiments;

FIG. 23 is a signal flowchart illustrating an example process of switching processing approaches related to an AI model according to various embodiments;

FIG. 24 is a block diagram illustrating an example model transmitter apparatus according to various embodiments;

FIG. 25 is a block diagram illustrating an example model receiver apparatus according to various embodiments; and

FIG. 26 is a block diagram of an example electronic equipment according to various embodiments.

### DETAILED DESCRIPTION

The description is provided below with reference to the accompanying drawings to facilitate a comprehensive understanding of various example embodiments of the present disclosure as defined by the claims and the equivalents thereof. This description includes various specific details to help with understanding, but should only be considered illustrative. Consequently, those ordinarily skilled in the art will realize that various embodiments described here can be varied and modified without departing from the scope and spirit of the present disclosure. In addition, the description of function and structure of common knowledge may be omitted for clarity and conciseness.

The terms and expressions used in the description and claims below are not limited to their lexicographical meaning but are used by the inventor to enable a clear and consistent understanding of the present disclosure. Therefore, it should be apparent that the following description of the various embodiments of the present disclosure is provided only for the purpose of the illustration without limiting the present disclosure as defined by the appended claims and their equivalents.

It will be understood that, unless specifically stated, the singular forms “one”, “a”, and “said” include the plural form. Thus, for example, the reference to “component surface” includes a reference to one or more such the surfaces.

The terms “includes” and “may include” may refer, for example to the presence of corresponding disclosed functions, operations, or components that can be used in various embodiments of the present disclosure, but do not limit the presence of one or more additional functions, operations, or features. In addition, it should be understood that the terms “including” or “having” may be interpreted to refer to certain features, numbers, steps, operations, components, assemblies or combinations thereof, but should not be interpreted to exclude the possibility of the existence of one or more of other features, numbers, steps, operations, components, assemblies and/or combinations thereof.

The term “or” as used in various embodiments of the present disclosure includes any listed term and all the combinations thereof. For example, “A or B” may include “A”, may include “B”, or may include both “A and B”.

Unless defined differently, all terms as used in the present disclosure (including technical or scientific terms) have the same meanings as understood by those skilled in the art as described in the present disclosure. As common terms defined in dictionaries are interpreted to have meanings consistent with those in the context in the relevant technical field, and they should not be idealized or overly formalized unless expressly defined as such in the present disclosure.

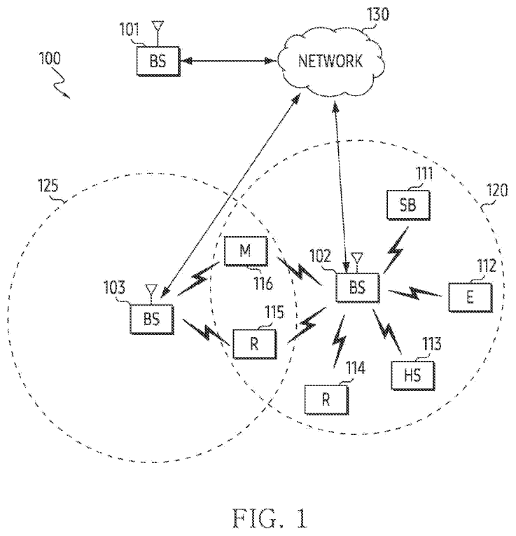

FIGS. 1 to 15 discussed below and various embodiments for describing the principles of the present disclosure are merely illustrative, and should not be construed in any way to limit the scope of the present disclosure. Those skilled in the art will understand that the principle of the present disclosure may be implemented in any suitably arranged system or equipment.

FIG. 1 illustrates an example wireless network 100 according to various embodiments. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” (BS) or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a commonly considered fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In various embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In various embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs.

Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

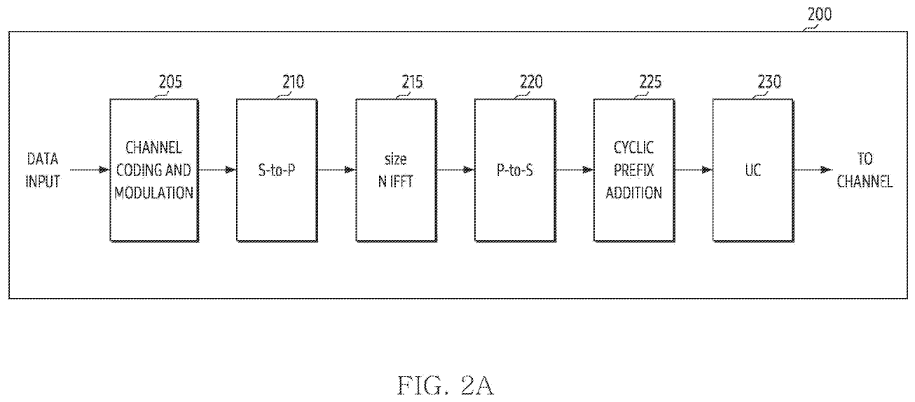

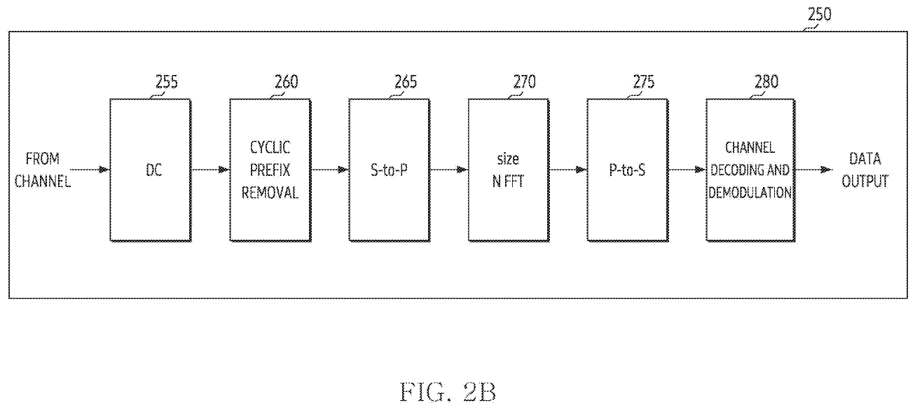

FIGS. 2A and 2B illustrate example wireless transmission reception paths according to various embodiments. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In various embodiments, the reception path 250 is configured to support codebook designs and structures for systems with 2D antenna arrays as described in example embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of the variable N may be any integer (such as 1, 2, 3, 4, etc.), while for FFT and IFFT functions, the value of the variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

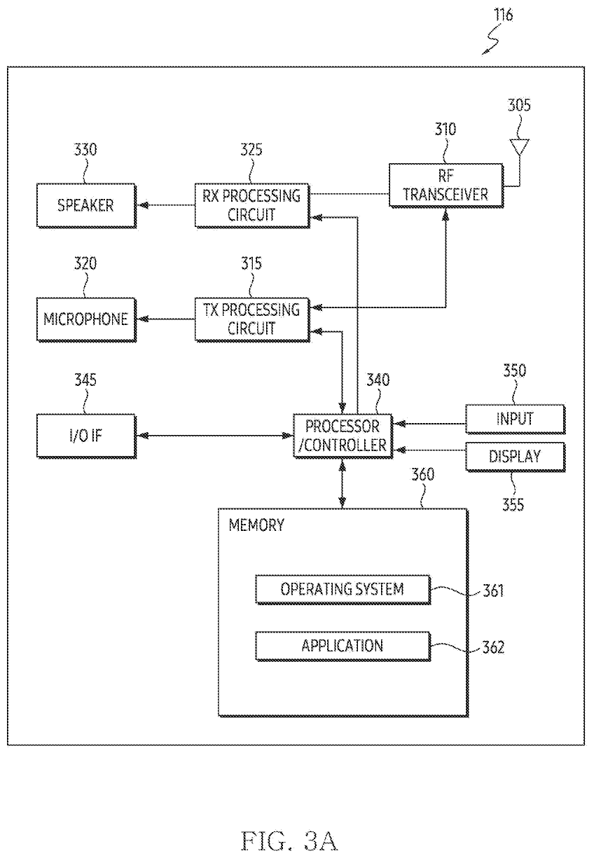

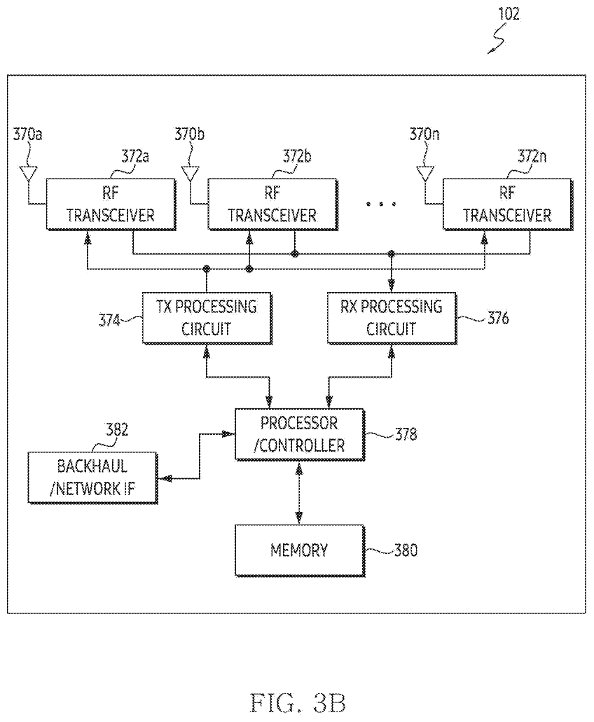

FIG. 3A illustrates an example UE 116 according to various embodiments. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 (including, e.g., processing circuitry and/or controller circuitry) can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In various embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in example embodiments of the present disclosure. The processor/controller 340 can move data into or out of the memory 360 as required by an execution process. In various embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to various embodiments. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In various embodiments, one or more of the plurality of antennas 370a-370n include a 2D antenna array. gNB 102 also includes a processor/controller 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to processor/controller 378 for further processing.

The TX processing circuit 374 receives analog or digital data (such as voice data, network data, email or interactive video game data) from the processor/controller 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The processor/controller 378 (including, e.g., processing circuitry and/or controller circuitry) can include one or more processors or other processing devices that control the overall operation of gNB 102. For example, the processor/controller 378 can control the reception of forward channel signals and the transmission of backward channel signals through the RF transceivers 372a-372n, the RX processing circuit 376 and the TX processing circuit 374 according to well-known principles. The processor/controller 378 can also support additional functions, such as higher-level wireless communication functions. For example, the processor/controller 378 can perform a Blind Interference Sensing (BIS) process such as that performed through a BIS algorithm, and decode a received signal from which an interference signal is subtracted. A processor/controller 378 may support any of a variety of other functions in gNB 102. In various embodiments, the processor/controller 378 includes at least one microprocessor or microcontroller.

The processor/controller 378 is also capable of executing programs and other processes residing in the memory 380, such as a basic OS. The processor/controller 378 can also support channel quality measurement and reporting for systems with 2D antenna arrays as described in example embodiments of the present disclosure. In various embodiments, the processor/controller 378 supports communication between entities such as web RTCs. The processor/controller 378 can move data into or out of the memory 380 as required by an execution process.

The processor/controller 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the processor/controller 378. A part of the memory 380 can include an RAM, while another part of the memory 380 can include a flash memory or other ROMs. In various embodiments, a plurality of instructions, such as the BIS algorithm, are stored in the memory. The plurality of instructions are configured to cause the processor/controller 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The example embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it will be apparent that modifications to the illustrated embodiments and examples can be made without departing from the scope of the present disclosure.

With the evolution of wireless communication systems, the advantages of artificial intelligence (AI) technology have been widely recognized in the industry to solve complex issues of future wireless communication. Attempts to use AI are increasingly being tried in the research and development of wireless air interface technology. 3GPP set up a project in R18 to discuss application of AI technology in the air interface.

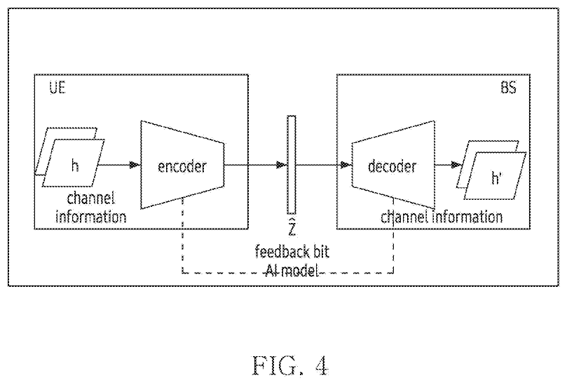

In related cases of AI applied to wireless communication, a user equipment (UE) and a base station (BS) have different levels of collaboration. In some cases, no additional interaction or coordination is required between a UE and a BS for use of AI, as long as one or both parties may use AI technology separately. In some other cases, additional interaction or coordination is required between a UE and a BS for the use of AI. For example, an example that requires a high degree of collaboration is an AI-based Channel State Information (CSI) feedback, and FIG. 4 illustrates a diagram of a deployment of models of AI-based CSI feedback. Different from the traditional feedback mechanism, in the example illustrated in FIG. 4, in an AI-based CSI compression feedback, a UE uses an AI model to perform feature extraction and compression on channel information (such as channel matrix h), after channel estimation, and the UE feeds back a compressed bit stream 2 to a BS. Accordingly, the BS uses an AI model to restore the channel information (such as reconstructing channel matrix h) before UE compression from 2 as far as possible. Here, the processing on the UE side can be called encoder, and the processing of the BS side is called decoder. In some cases, training of an AI model may be completed by either the BS or the UE, but it requires both parties to cooperate to use the corresponding model at an inferring phase. For example, in an AI-based CSI feedback mechanism described in FIG. 4, in a training phase of an AI model, one of the BS and the UE may complete joint training of the encoder and decoder, while in the inferring phase (i.e., a use phase) of the AI model, the encoder and decoder run on the UE and the BS, respectively. Thus, after the AI model is trained, the encoder and the decoder need to be delivered to the UE and the BS respectively for deployment in some way, that is, transmission of AI model is required. However, in the current wireless communication system, there are no processes and methods related to the transfer of AI models.

Therefore, the present disclosure provides a method for transmitting and receiving AI models in wireless communication systems. In this method, considering that the resource overhead for transmitting AI models themselves is relatively large, a model attribute and a specific AI model (i.e., a model itself) are transmitted separately. By a model transmitter indicating the model attribute to a model receiver and the model receiver expressing its AI capability to the model transmitter, which models the model receiver supports, which models are more suitable for transmission in the current situation, which models are not necessarily transferred can be predetermined and, in this way, the models that need to be transferred are screened out, and this reduces the overhead for transmitting models. In addition, by such the screening, in a case in which the model transmitter is the BS, the BS may select the more suitable transmission mode (broadcast/unicast/multicast) to transmit the models to further reduce the overhead for transmitting the models. In addition, an ultimate purpose of model transmission is to implement a corresponding function by executing a model, and considering that it is difficult to pre-estimate an actual execution status of the AI model only based on the model attribute and the AI capability, the present disclosure proposes that after the model transfer, the model receiver gives feedback on the actual model execution status to the model transmitter so as to ensure the subsequent normal use of models and achieve the expected execution.

In addition, considering the generalization performance and complexity of the AI model, for a communication functionality, it is necessary to switch between different processing approaches (that is, approaches based on different AI models and non-AI model based approaches) to obtain a better performance. In order to realize the coordination in an AI-based algorithm between the UE and the BS, it is necessary to specify a time when the UE starts to execute a target processing approach. For example, in some scenarios, the UE needs to report an inference result of a UE-side AI model to the BS, and the BS needs to use a BS-side AI model corresponding to the UE-side AI model to parse the inference result reported by the UE. If the AI models (or processing approaches) used by the BS and UE sides do not match, the BS can not parse correct information.

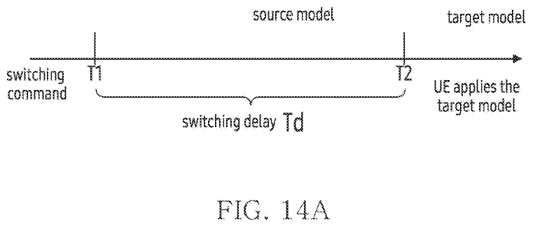

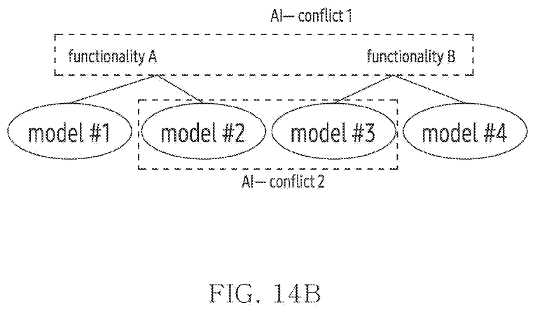

In addition, after the UE receives a switching command from the BS, it takes a certain amount of time for the UE to complete the switching, for example, preparing an AI model related to a target processing approach. The preparation process may include, for example, converting a target AI model into a UE-specific executable format, loading parameters related to the target AI model into a memory, instantiating the target AI model, and the like. An easier way to think about is to set a sufficiently large time, such as Td in FIG. 14A, to cover all possible situations as much as possible, or to set different Td's according to different UE capability levels to cover all possible switching situations of a UE at a capability level, but these methods will introduce unnecessary switching delay. This is because, in different cases, the same UE requires different switching delays, for example, a time taken for preparing an AI model.

To this end, the present disclosure also proposes a method to determine Td, (e.g., T2=T1+Td, where T2 is a time when the target processing approach starts to be applied) according to features of the target processing approach and/or a source processing approach and the like, so as to shorten the switching delay. In addition, the present disclosure also proposes a corresponding solution for an interruption time occurring during the switching process of the processing approach (e.g., the UE can neither apply the source processing approach nor the target processing approach within the interruption time). Meanwhile, the present disclosure also proposes solutions to avoid collision and compatibility issues when multiple functionalities switch the processing approaches at the same time. In the various methods proposed in the present disclosure, the mentioned processing approaches include AI model-based processing approaches and non-AI processing approaches, and the switching of the processing approaches includes switching between different AI models, and switching between the AI model-based processing approach and the non-AI processing approach. In the present disclosure, although the processing approaches are divided according to the AI model-based processing approach and the non-AI processing approach, this is only an example. The AI model-based processing approach is only an example of the more advanced processing approach than the non-AI processing approach. Any term that may reflect a similar classification method is included in the scope disclosed in the present disclosure. For example, in an example embodiment, the division of the processing approaches is defined according to the features of the processing approaches (such as the required processing resource overhead and time overhead). For example, in some cases, the processing approaches may be divided into advanced processing approaches and common processing approaches based on the features of the processing approaches (such as the processing resource overhead and time overhead), instead of dividing the processing approaches based on specific models.

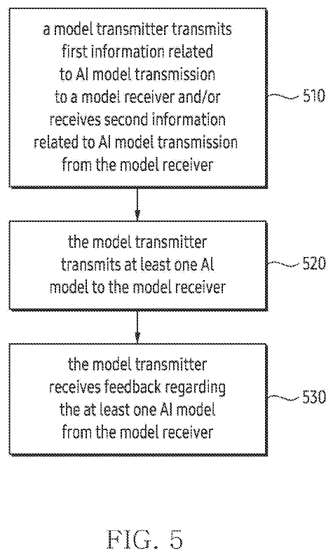

FIG. 5 is a flowchart of an example transmission method of an AI model according to various embodiments. A detailed description of steps unrelated to the present disclosure is omitted here.

In operation 510, a model transmitter transmits first information related to AI model transmission to a model receiver and/or receives second information related to AI model transmission from the model receiver.

In operation 520, the model transmitter transmits at least one AI model to the model receiver.

In operation 530, the model transmitter receives feedback regarding the at least one AI model from the model receiver.

Considering that different equipments have different computing capabilities, different AI models have different application scopes and performances. Thus, in different cases, different AI models need to be transferred between the UE and the BS. Taking an AI-based CSI feedback as an example, different AI models have different generalization capabilities, accuracy, and feedback overhead (i.e., feedback bit number), and are applicable to different situations. The computing capability on the UE side will directly affect the deployment of the encoder and the selection of AI models. When the AI model is transferred between the model transmitter and the model receiver, it can be divided based on the model transmitter and the model receiver being different devices. There are two specific situations.

In a first situation, the model transmitter is the BS, and the model receiver is the UE. For example, if an AI-based CSI feedback is taken as an example, a training process of an AI model is completed in the BS, and the BS needs to at least deliver an AI model of an encoder part to the UE.

In a second situation, the model transmitter is the UE, and the model receiver is the BS. For example, if an AI-based CSI feedback is taken as an example, the training process of the AI model is completed in the UE, and the UE needs to at least deliver an AI model of a decoder part to the BS.

The above situations will be described in detail below with reference to the accompanying drawings.

The step of transmitting, by the model transmitter, the first information related to the AI model transmission to the model receiver may include, for example, transmitting, by the model transmitter, a model attribute to the model receiver.

In the present disclosure, the model attribute may refer, for example, to information for describing properties of various aspects of the model such as a purpose, a complexity, a performance etc. Specifically, the model attribute may include at least one of the following information: model complexity (i.e., model complexity related attributes), model input and/or output (i.e., model input and output attributes), a model application scope, a model transmission scheme (i.e., a transmission scheme of the model itself) and/or a time-frequency resource indication. In the present disclosure, the model (i.e. the model itself) may refer, for example, to a program or algorithm or neural network for performing specific communication tasks and implementing specific functions, and its form may include, but is not limited to, executable programs, files describing parameters and structure of neural networks, etc. Example model attributes are described in detail below.
(1) Model complexity related attributes: for indicating floating point operations (FLOPs) or FLOPs levels of the model, a size or size grade of the model, a backbone network type (such as CNN, Transformer etc.) of the model and the like. The model receiver may preliminarily determine which models are within a supportable scope, i.e., preliminarily determine which models it supports, according to the various indexes indicated in the above-described model complexity in conjunction with its own AI capability. For example, the model receiver may pre-estimate the model execution time according to the FLOPs or FLOPs level of the model in conjunction with its own computing capability, and/or the model receiver may determine a video memory space occupied by the model when it is running according to the size or size grade of the model. In addition, since some implementation designs (such as a hardware, software running environment) will make special optimization for specific types of neural networks, the backbone network type of the mode may provide more information to the model receiver for evaluating a support situation for the model.
(2) Model input and/or output attribute(s): indicating content, data dimension etc. of input and/or output of the model. The model receiver may learn the purpose of the model and preliminarily determine which models are within the supportable scope, i.e., preliminarily determine which models it supports, according to the model input and/or output attribute(s). For example, as for the AI-based CSI feedback issue as illustrated in FIG. 4, input content of the encoder may be full channel information H or channel characteristic information W, of which a data form may be a multidimensional matrix, and the dimension of the multidimensional matrix is different in different cases; output content of the encoder is CSI feedback information, of which a data dimension is a vector of length n, wherein n is the number of feedback bits; input and/or output attributes of a decoder are opposite to those of the encoder, its input content is CSI feedback information, of which a data dimension is a vector of length n, where n is the number of feedback bits, output content of the decoder is full channel information H or channel characteristic information W, of which a data form is a multidimensional matrix, and the multidimensional matrix has different dimensions in different cases.
(3) Model application range: for indicating applicable conditions of the model, wherein the model application range includes a model applicable cell range and/or a model applicable SNR range.

The model applicable cell range may be indicated by a neighbor cell list and/or cross-cell model ID identification, wherein the neighbor cell list is used to indicate current neighbor cells to which the model is applicable. A purpose of the cross-cell model ID identification is that, when the UE switches to another cell, and if this cell also indicates the model with the same ID, the UE may continue to use the model identified by the ID. In addition, the model ID identification may also be used by the model receiver to determine which models the model receiver supports or which models are already possessed thereby. For example, taking the AI-based CSI feedback as an example, an AI-based solution may make cell-specific optimization, that is, collect data from a specific cell and train an AI model for this cell. However, considering the mobility of the UE and the training cost of individual optimization for each cell, it is likely to jointly train a model focusing on generalization performance for multiple cells with similar coverage scenarios or multiple neighbor cells, and these cells may have similar distribution of channel characteristics due to the similar coverage scenarios. When the UE is moving within an area including these cells, it may continue to use the model so as to avoid resource overhead caused by frequent switching of the model. Specifically, in an embodiment, the neighbor cell list and cross-cell model ID identification may be used to indicate the model applicable cell range. For example, if the UE switches to a cell indicated in the neighbor cell list, the model ID identification is valid for the cell, and the cell also indicates the model with the same ID, then the UE may continue to use the AI model indicated by the ID identification, that is to say, the cross-cell model ID identification is valid in the neighbor cell list and the cell range. In an embodiment, the cross-cell model ID identification may be used to indicate the model applicable cell range. For example, if the model ID identification is a unique identification of the whole network, that is, it is used to uniquely indicate an AI model within the whole network range, then regardless of which cell in the whole network range the UE is located in, the model ID identification is valid, and can be used to uniquely indicate an AI model within the whole network range. In an embodiment, the neighbor cell list may be used to indicate the model applicable cell range. For example, the BS transmits an AI model to the UE, the AI model is applicable to a neighbor cell range, and the UE unilaterally uses the AI model. That is to say, unlike the AI-based CSI feedback, the BS does not require any operation to cooperate with the UE to use the AI model, which will not affect the communication task between the UE and the BS.

For the model applicable SNR range, considering that different AI models bring different gains under different SNRs, or different models are trained for different SNR situations, the model receiver may determine which model is more appropriate for transferring according to the actual SNR situation and the applicable SNR range indicated in the model attributes.
(4) Model transmission scheme and/or time-frequency resource indication: the model transmission scheme may be used, for example, to indicate which method is adopted to transmit a model, e.g., broadcast, multicast and/or unicast and the time-frequency resource indication may be used, for example, to identify a time-frequency resource for transmitting a model.

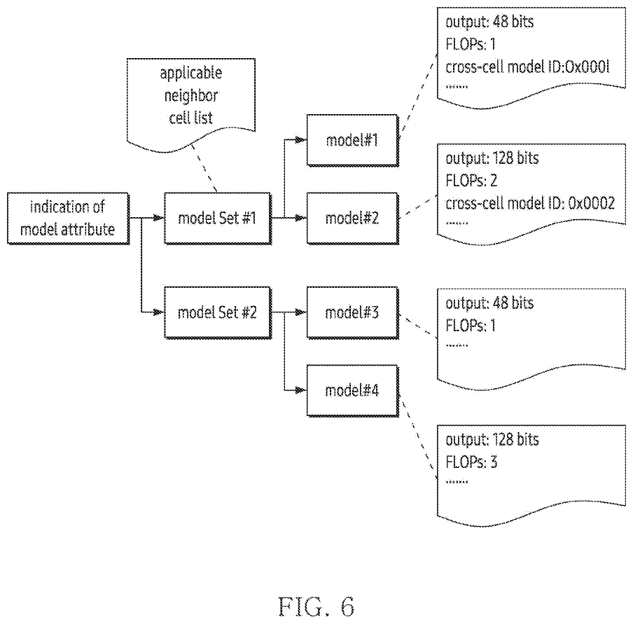

In addition, different models may be formed into different model sets. The above model attributes may be configured for a model or a model set. If a model attribute is configured for a model set, a value of the model attribute is the same for all models in the set, thereby further saving the overhead for indicating the model attribute. Taking the AI-based CSI feedback as an example, the BS may form different model sets with different models according to dimensions such as the complexity, the generalization performance, the feedback overhead, the accuracy and so on. FIG. 6 provides a specific example, wherein FIG. 6 illustrates an example of a model attribute indication structure according to various embodiments. In the model attribute indication structure as illustrated in FIG. 6, a Model Set #1 has a same neighbor cell list. In addition, the model attribute may be transmitted using different transmission schemes, for example, the model attribute may be transmitted by a broadcast scheme, a multicast scheme or a unicast scheme. Specifically, in a case that the model transmitter is a BS and the model receiver is a UE, the model transmitter may transmit the model attribute to the model receiver by any transmission scheme in the broadcast scheme, the multicast scheme or the unicast scheme. For example, when it needs to indicate the same model attribute to a plurality of receivers, the model attribute may be transmitted by the broadcast scheme, to thereby further save signaling overhead generated by the indication. The unicast scheme may be flexibly for indicating a specific model to a model receiver. However, as for a case in which the UE is the model transmitter and the BS is the model receiver, the model attribute may be indicated to the BS only by using the unicast scheme, and the AI model may be transmitted to the BS only by the unicast scheme.

The step of receiving, by the model transmitter, the second information related to the AI model transmission from the model receiver may include, for example, receiving, by the model transmitter, an inherent AI capability and/or a model support capability of the model receiver, from the model receiver. That is, the second information related to the AI model transmission at least includes the inherent AI capability and/or model support capability.

In the present disclosure, the inherent AI capability and the model support capability can be collectively referred to, for example, as AI capability, wherein the inherent AI capability represents the inherent AI capability possessed by the model receiver itself, which is a static/semi-static attribute. The model support capability represents AI capability by indicating the model/model set for the received model attribute, that is, indicating the AI models that the model receiver can support among the AI models indicated by the model attribute and/or indicating the AI models already possessed by the model receiver among the AI models indicated by the model attribute. In other words, the model support capability is used to indicate, for example, which AI models among the AI models indicated by the model attribute the model receiver can support and/or indicate which AI models among the AI models indicated by the model attribute are already possessed by the model receiver.

The inherent AI capability and the model support capability are described in detail below.
(1) The inherent AI capability may include, for example, the following information.
   a) a computing capability level, evaluated using floating point operations per second (FLOPS) or FLOPS level.
   b) a module(s) and/or functionality(s) that support receiving and deploying AI models to implement a corresponding communication task.
   (c) a maximum number of AI models that can be supported for simultaneous deployment for each of the module(s) and/or functionality(s).
   d) an upper limit for a size of a single AI model supported.
   e) an upper limit for an overall size of the models that are deployed simultaneously.
   f) whether to support receiving auxiliary models for correction and/or performance detection. For example, as for the AI-based CSI feedback, the UE only requires the encoder to complete the feedback of CSI. In fact, the decoder is an auxiliary model for the UE, and, if the UE supports receiving the auxiliary model, the UE may use the decoder to perform performance detection, such as evaluating a similarity between an input h of the encoder and an output h of the decoder.
   g) whether to support feedback of raw data. For example, as for the AI-based CSI feedback, if the UE can feed back raw input h of an encoder, the BS then may perform online data collection on one hand, and may evaluate performance of the current model through the similarity between h and h on the other hand.
(2) Model support capability, that is, indicating AI capability by indicating a model/model set for the received model attribute:
   a) indicating that the model receiver pre-determines which models/model sets it supports by indicating the model/model set. By a predetermination based on the received model attribute and its own AI capability, the model receiver indicates which models/model sets it supports in the predetermination, to the model transmitter. For example, it is capable of indicating which models/model sets it supports in the predetermination, by the model ID identification in the model attribute.
   b) indicating which models/model sets are already possessed by the model receiver by indicating the model/model set. The receiver indicates which models/model sets already possessed thereby are executable based on the received model attribute, and the model transmitter may not transmit them repeatedly. For example, the model ID identification in the model attribute may be used to indicate which models/model sets already possessed are executable.

For different scenarios, the inherent AI capability and/or the model support capability may be transmitted from the model receiver to the model transmitter by different transmission schemes. For example, in a case in which the model transmitter is the BS and the model receiver is the UE, the inherent AI capability and/or the model support capability are/is transmitted from the model receiver to the model sender by the unicast scheme; however, in a case in which the model transmitter is the UE and the model receiver is the BS, the inherent AI capability is transmitted from the model receiver to the model transmitter by any transmission scheme in the unicast scheme, the multicast scheme and the broadcast scheme, and the model support capability is transmitted from the model receiver to the model transmitter by the unicast scheme.

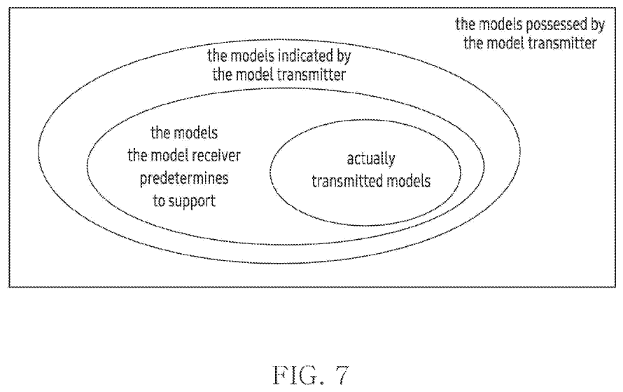

The at least one AI model transmitted by the model transmitter to the model receiver is indicated by the model transmitter in the model attribute. Specifically, in various embodiments, the at least one AI model is selected from the AI models indicated by the model attribute. In this case, referring to FIG. 7, a range of the AI models indicated by the model attribute (i.e., a range of the model indicated by the model transmitter) is greater than or equal to a range of the at least one AI model (i.e., a range of the model that is actually transmitted). In various embodiments, the at least one AI model is all AI models indicated by the model attribute. In this case, referring to FIG. 7, the range of AI models indicated by the model attribute (that is, the range of the model indicated by the model transmitter) is equal to the range of the at least one model (that is, the range of the model that is actually transmitted). For example, the BS, as the model transmitter, selects some AI models suitable for most situations according to its own demands or according to experience data (such as the feedback for the use of the models and the long-term, inherent AI capabilities of most UEs), and then broadcasts the selected models and their model attributes through the broadcast scheme. At this time, the range of the model indicated by the model attribute is equal to the range of the AI model that is actually transmitted. In addition, the at least one AI model is selected by the model transmitter according to at least one of following information: the inherent AI capability of the model receiver, the model support capability of the model receiver, a model execution result of the model receiver, or the model transmitter's own demands, wherein the model execution result of the model receiver may include whether the at least one AI model is correctly executed by the model receiver and/or execution efficiency of the at least one AI model, and is fed back by the model receiver to the model transmitter.

In addition, for different scenarios, using a different transmission scheme to transmit the AI model may cause different efficiency and overhead. Thus, for different scenarios, the at least one AI model may be transmitted from the model transmitter to the model receiver through different transmission schemes. For example, in a case in which the model transmitter is the BS and the model receiver is the UE, the at least one AI model may be transmitted from the model transmitter to the model receiver through any transmission scheme in the unicast scheme, the multicast scheme and the broadcast scheme. However, in a case in which the model transmitter is the UE and the model receiver is the BS, the at least one AI model may be transmitted from the model transmitter to the model receiver by the unicast scheme.

The step of receiving, by the model transmitter, the feedback regarding the at least one AI model from the model receiver includes, for example, receiving, by the model transmitter from the model receiver, feedback regarding whether the at least one AI model is executed correctly and/or execution efficiency of the at least one AI model. Specifically, considering factors such as a model design, a software environment, hardware implementation, it can be difficult to accurately evaluate or estimate the performance when the AI model is specifically executed only based on the model complexity related attributes and the inherent AI capability of the model receiver. Therefore, after receiving the AI model, the model receiver needs to feed back execution status of the AI model to the model transmitter including the following
(1) confirming whether the received AI model is executable;
(2) a computing time required for implementing a corresponding function by executing the AI model.

For example, taking the AI-based CSI feedback as an example, if the UE feeds back to the BS that a computing time required for implementing the CSI feedback by executing the AI model is T, the UE may feedback CSI information to the BS after time T upon reception of a last CSI-RS signal for this CSI computation by the UE.

The model receiver gives the feedback on the execution status of the AI model to the model transmitter so as to ensure the subsequent normal use of the model and achieve the expected execution. In addition, as illustrated in FIG. 7, it can be clearly seen through the above-described transmission method of the AI model that {actually transmitted models}⊆{the models the model receiver predetermines to support}⊆{the models indicated by the model transmitter}⊆{the models possessed by the model transmitter}, and by such screening, for a case in which the model transmitter is the BS, the BS may select the more suitable transmission scheme (broadcast/unicas/multicast) to transmit the model to further reduce the overhead for transmitting the model.

In the present disclosure, the various operations involved in the above description (such as the transmission operation of the model attribute, the transmission operation of the inherent AI capability, the transmission operation of the model support capability, the transmission operation of the AI model, and the feedback operation regarding the AI model) may be performed in different combinations and sequences, and some operations may also be performed multiple times.

For example, in an embodiment, if the model transmitter determines that all the AI models indicated by the model attribute transmitted by the model transmitter to the model receiver are not suitable for the model receiver according to the inherent AI capability and/or the model support capability, the operation 510 may be re-performed, that is, the model transmitter transmits new first information related to AI model transmission to the model receiver and/or receives new second information related to AI model transmission from the model receiver; that is to say, the model transmitter transmits a new model attribute to the model receiver and receives a new model support capability from the model receiver. Then then the operations 520 and 530 are performed. Specifically, the model transmitter selects at least one AI model to be transmitted according to the received model support capability and/or the previously received inherent AI capability, transmits the selected at least one AI model to the model receiver, and finally receives feedback regarding the at least one AI model from the model receiver.

In an embodiment, if the model transmitter determines that the at least one AI model is not suitable for the model receiver according to the feedback in the operation 530, the model transmitter re-performs the operations 510 to 530. That is, the model transmitter transmits new first information related to AI model transmission to the model receiver and/or receives new second information related to AI model transmission from the model receiver, transmits at least one other AI model to the model receiver, and receives feedback regarding the at least one other AI model from the model receiver. Specifically, when the operation 510 is performed again, the model transmitter may transmit a new model attribute to the model receiver, and receive a new model support capability from the model receiver. However, since the model transmitter has previously received the inherent AI capability from the model receiver, the model transmitter may not receive the inherent AI capability from the model receiver when performing the operation 510 again, but the present disclosure is not limited thereto, and the model transmitter may also re-receive the inherent AI capability of the model receiver. Hereinafter, in the operation 520, the model transmitter re-selects at least one other AI model to be transmitted according to the inherent AI capability and/or the new model support capability, transmits the re-selected at least one other AI model to the model receiver, and receives feedback regarding the at least one other AI model from the model receiver in the operation 530.

In the present disclosure, as described above, the model attribute includes, for example, at least one of following various attributes: model complexity related attributes, model input and output attributes, a model application range, a transmission scheme of a model, or a time-frequency resource indication. For the newly transmitted model attribute and the previously transmitted attribute, they may be different in at least one of a type and a value of the attribute, for example, the newly transmitted model attribute and the previously transmitted attribute both include the same type of the attribute, but the values of the attributes may be different. For example, including two types of attributes, i.e., the FLOPs level and the model application range, wherein their FLOPs levels are the same, but the model application ranges are different. For another example, the newly transmitted model attribute and the previously transmitted model attribute include attributes of types that are not exactly the same. For example, the previously transmitted model attribute includes the input/output attributes and the FLOPs level, but the newly transmitted model attribute includes the FLOPs level and the model application range, and the FLOPs levels included in the two are also different. In addition, the new model support capability is used to indicate which AI models among the AI models indicated by the new model attribute the model receiver can support and/or indicate which AI models among the AI models indicated by the new model attribute are already possessed by the model receiver.

In an embodiment, the model transmitter may first receive from the model receiver its inherent AI capability. Then, the model transmitter may select an appropriate AI model according to the inherent AI capability of the model receiver and indicate the model attribute of the selected AI model to the model receiver. Thereafter, the model transmitter may receive the model support capability from the model receiver, select at least one AI model among the AI models indicated by the model attribute according to the inherent AI capability and/or the model support capability, and then transmit the at least one AI model to the model receiver through one transmission method of the multiple transmission methods. Finally, the model transmitter may receive feedback regarding the at least one AI model from the model receiver.

In an embodiment, the model transmitter may first receive from the model receiver its inherent AI capability, and then the model transmitter may select an appropriate AI model according to the inherent AI capability of the model receiver. Thereafter, the model transmitter may select at least one AI model according to the inherent AI capability, and then transmit the at least one AI model to the model receiver through one transmission method of the multiple transmission methods. Finally, the model transmitter may receive feedback regarding the at least one AI model from the model receiver. In the above process, the model transmitter may not transmit the model attribute to the model receiver.

In an embodiment, the model transmitter may first transmit the model attribute to the model receiver, the model transmitter may receive the inherent AI capability and the model support capability from the model receiver, and, if the model transmitter determines that the AI model indicated by the previously transmitted model attribute is not suitable for the model receiver according to the inherent AI capability and/or the model support capability (for example, the model transmitter may determine that the computing capability level in the inherent AI capability reported by the model receiver is very high, but the complexity of the model indicated by the previously transmitted model attribute is relatively low. Then, the model transmitter may determine that the AI model indicated by the previously transmitted model attribute is not suitable for the model receiver, and the model transmitter may transmit a new model attribute to the model receiver to indicate an AI model with high complexity. Thereafter, the model transmitter may receive a new model support capability from the model receiver, select an AI model to be transmitted according to the inherent AI capability and/or the new model support capability, and transmit the selected AI model to the model receiver. Then, the model transmitter may receive feedback regarding the AI model from the model receiver.

In an embodiment, the model transmitter may first transmit the model attribute to the model receiver, and then transmit the AI model indicated by the model attribute to the model receiver. After that, the model transmitter may receive the inherent AI capability and/or the model support capability and feedback regarding the AI model from the model receiver.

In an embodiment, the model transmitter may first receive from the model receiver its inherent AI capability, then the model transmitter may select an appropriate AI model according to the inherent AI capability of the model receiver and indicate the model attribute of the selected AI model to the model receiver. Thereafter, the model transmitter may transmit the selected AI model to the model receiver, and the model transmitter may receive feedback regarding the AI model from the model receiver.

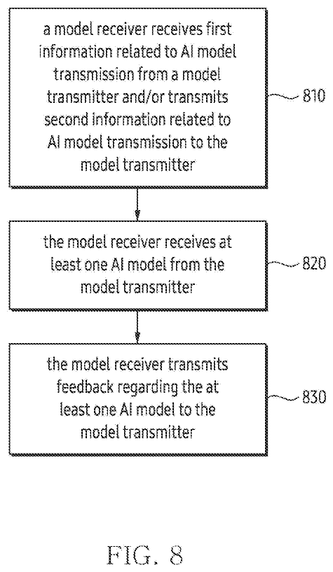

FIG. 8 is a flowchart of a reception method of an AI model according to various embodiments. To avoid repetition, content already described when describing the transmission method of the AI model with reference to FIG. 5 is not repeated in the description below.

As illustrated in FIG. 8, in operation 810, a model receiver receives first information related to AI model transmission from a model transmitter and/or transmits second information related to AI model transmission to the model transmitter.

In operation 820, the model receiver receives at least one AI model from the model transmitter.

In operation 830, the model receiver transmits feedback regarding the at least one AI model to the model transmitter.

The step of receiving, by the model receiver, the first information related to the AI model transmission from the model transmitter may include, for example, receiving, by the model receiver, a model attribute from the model transmitter.

In the present disclosure, the model attribute includes, for example, at least one of the following information: a model complexity, model input and/or output, a model application range, a transmission scheme of a model, or a time-frequency resource indication. The time-frequency resource indication may be used, for example, to identify a time-frequency resource for transmitting a model. The model application range may include, for example, a model applicable cell range and/or a model applicable SNR range, and the model applicable cell range ma be indicated, for example, by a neighbor cell list and/or cross-cell model ID identification. For different scenarios, the model attribute may be transmitted using different transmission schemes. For example, the model attribute may be transmitted by a broadcast scheme, a multicast scheme or a unicast scheme. Specifically, for a case in which the model transmitter is the BS and the model receiver is the UE, the model transmitter may transmit the model attribute to the model receiver by any transmission scheme in the broadcast scheme, the multicast scheme and the unicast scheme. However, as for a case in which the UE is the model transmitter and the BS is the model receiver, the model attribute may be transmitted to the BS only by using the unicast scheme.

The step of transmitting, by the model receiver, the second information related to the AI model transmission to the model transmitter may include, for example, transmitting, by the model receiver, an inherent AI capability and/or a model support capability of the model receiver, to the model transmitter.

In the present disclosure, the model support capability may indicate, for example, AI models that the model receiver may support among the AI models indicated by the model attribute received by the model receiver from the model transmitter and/or may indicate AI models already possessed by the model receiver among the AI models indicated by the model attribute. The inherent AI capability may include, for example, at least one of the following information: a computing capability level, a module(s) and/or functionality(s) that support(s) receiving and deploying AI models to implement a corresponding communication task, the maximum number of AI models that may be supported for simultaneous deployment by each of the module(s) and/or functionality(s), an upper limit for a size of a single AI model that may be supported, an upper limit for an overall size of AI models that are deployed simultaneously, whether to support receiving auxiliary models, or whether to support feedback of raw data.

For different scenarios, the inherent AI capability and/or the model support capability may be transmitted from the model receiver to the model transmitter by different transmission schemes. For example, in a case in which the model transmitter is the BS and the model receiver is the UE, the inherent AI capability and/or the model support capability may be transmitted from the model receiver to the model transmitter by the unicast scheme. However, for a the case in which the model transmitter is the UE and the model receiver is the BS, the inherent AI capability may be transmitted from the model receiver to the model transmitter by any transmission scheme in the unicast scheme, the multicast scheme and the broadcast scheme, and the model support capability may be transmitted from the model receiver to the model transmitter by the unicast scheme.

The at least one AI model is indicated in the model attribute by the model transmitter, wherein the at least one AI model may be selected by the model transmitter according to at least one of the following information: the inherent AI capability of the model receiver, the model support capability of the model receiver, a model execution result of the model receiver, or the model transmitter's own demands.

In addition, for different scenarios, the at least one AI model may be transmitted from the model receiver to the model transmitter through different transmission schemes. For example, as in the case in which the model transmitter is the BS and the model receiver is the UE, the at least one AI model may be transmitted from the model transmitter to the model receiver through any transmission scheme in the unicast scheme, the multicast scheme and the broadcast scheme. However, as for the case in which the model transmitter is the UE and the model receiver is the BS, the at least one AI model may be transmitted from the model transmitter to the model receiver by the unicast scheme. In addition, if the model transmitter determines that the AI models indicated by the model attribute are not suitable for the model receiver according to the inherent AI capability and/or the model support capability, or if the model transmitter determines that the at least one AI model is not suitable for the model receiver according to the result of the feedback, the model transmitter may transmit a new model attribute to the model receiver, and receive a new model support capability from the model receiver.

In addition, in the present disclosure, the step of transmitting, by the model receiver, the feedback regarding the at least one AI model to the model transmitter may, for example, include transmitting, by the model receiver to the model transmitter, feedback regarding whether the at least one AI model is executed correctly and/or execution efficiency of the at least one AI model.

In the present disclosure, the various operations, such as the transmission operation of the model attribute, the transmission operation of the inherent AI capability, the transmission operation of the model support capability, the transmission operation of the AI model, and the feedback operation regarding the AI model, are involved in the above description. Although these operations in the above description are described to be performed once in a certain order, the present disclosure is not limited thereto, and at least some operations among the above various operations may be performed multiple times in different combinations and/or orders.

For example, in an embodiment, when the operation 810 is performed, if the model transmitter determines that all the AI models indicated by the model attribute received by the model receiver from the model transmitter are not suitable for the model receiver according to the inherent AI capability and/or the model support capability, the operation 810 may be re-performed. That is, the model receiver may receive new information related to AI model transmission from the model transmitter and/or transmit new information related to AI model transmission to the model transmitter. That is to say, the model receiver may receive a new model attribute from the model transmitter, and transmit a new model support capability to the model transmitter. Then, the operations 820 and 830 may be performed.

For another example, in an embodiment, after the operation 830 is performed, if the model transmitter determines that the at least one AI model is not suitable for the model receiver according to the feedback, the operations 810 to 830 may be re-performed. That is, the model receiver may receive new first information related to AI model transmission from the model transmitter and/or transmit new second information related to AI model transmission to the model transmitter, receive at least one other AI model from the model transmitter, and transmit feedback regarding the at least one other AI model to the model transmitter.

Descriptions of various example embodiments described above with reference to FIG. 5 are not be repeated here again.

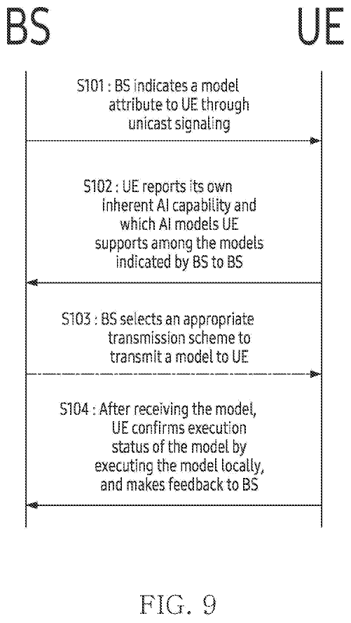

Specific examples of the above transmission and reception methods of the AI model will be described in detail below with reference to FIGS. 9, 10, 11, 12, and 13.

FIG. 9 is a flowchart illustrating an example of transmitting a model by a BS to a UE according to various embodiments. This example may be suitable, for example, for a situation in which the BS has multiple models and needs to transmit different models to different UEs. As illustrated in FIG. 9, the model transmitter is the BS, and the model receiver is the UE. The BS transmits an AI model for CSI feedback to the UE.

In operation S101, the BS indicates a model attribute to the UE through unicast signaling. For example, the structure of an indication of the model attribute transmitted by the BS to the UE is shown in FIG. 6. As illustrated in FIG. 6, the indication of the model attribute is used for two model sets, i.e., a Model Set #1 and a Model Set #2, where the Model Set #1 are CSI feedback models suitable for the UE moving in an area containing multiple cells. The Model Set #1 includes a Model #1 and a Model #2, and the Model #1 and the Model #2 correspond to different output data (that is, different number of feedback bits) and FLOPs levels. The output data of the Model #1 is 48 bits and the FLOPs level of the Model #1 is 1, and the output data of the Model #2 is 128 bits and the FLOPs level of the Model #2 is 2. The Model Set #2 are CSI feedback models suitable for the present cell, and the Model Set #2 includes a Model #3 and a Model #4. The Model #3 and the Model #4 correspond to different output data (that is, different number of feedback bits) and FLOPs levels, where output data of the Model #3 is 48 bits and the FLOPs level of the Model #3 is 1, and output data of the Model #4 is 128 bits and the FLOPs level of the Model #4 is 3.

In operation S102 the UE reports its own inherent AI capability and which AI models the UE supports among the models indicated by the BS to the BS. For example, the UE reports following content to the BS: its own computing capability level (e.g., the FLOPS level) is 2, being capable of supporting deploying two models simultaneously and the like. For models indicated by the BS in the operation S101, the supported models indicated by the UE are {Model #1, Model #3}.

In operation S103, the BS selects an appropriate transmission scheme to transmit a model to the UE. For example, the BS selects different transmission schemes to transmit different models according to the demand of the UE for the models in the present cell and resource scheduling in the cell, for example:
the BS needs to transmit Model #1 to multiple UEs within the self-service cell, so the BS transmits Model #1 to the multiples the UE by multicast scheme;
the BS only needs to transmit Model #3 to a few UEs within the self-service cell, and these UEs cannot be multicast scheduled, so the BS transmits Model #3 to each UE among these few UEs by the unicast scheme.

In operation S104, after receiving the model, the UE confirms execution status of the model by executing the model locally, and makes feedback to the BS. For example, after receiving Model #1 and Model #3, the UE executes Model #1 and Model #3 to complete corresponding functions, respectively. The UE informs the base station that these two models are correctly executed and indicates the corresponding execution efficiency, for example, by feeding back execution time t₁ corresponding to Model #1 and execution time t₃ corresponding to Model #3.

The BS preliminarily determines the support situation of the UE by high efficient signaling interaction, selects an appropriate transmission method based on the support situation indicated by the UE, and performs a downlink transmission of models systematically, thereby saving the resource overhead.

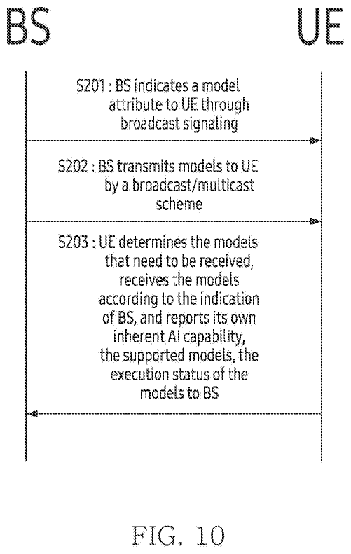

FIG. 10 is a flowchart of an example of transmitting a model by a BS to a UE according to various embodiment. The example is suitable, for example, for a phase in which the related technology and application are relatively mature, for example, there are many UEs supporting AI-based CSI feedback in the cell, and the BS needs to transmit the same or several models to many UEs. As illustrated in FIG. 10, the model transmitter is the BS, and the model receiver is the UE. The BS transmits an AI model for CSI feedback to the UE.

In operation S201, the BS indicates a model attribute to the UE through broadcast signaling. For example, the BS indicates to the UE that the models are Model Set #1 as illustrated in FIG. 6, and indicates how to receive models contained in the model set in the attribute of the model set.

In operation S202, the BS transmits AI models indicated in the operation S201 to the UE by a broadcast/multicast scheme.

In operation S203, the UE determines the models that need to be received, receives the models according to the indication of the BS, and reports its own inherent AI capability, the supported models, the execution status of the models to the BS. For example:
UE A switches from another cell to a current cell, compares the cross-cell model ID through the model indication broadcasted in the operation S201, and finds that there are already Model #1 and Model #2, which have been received and used in the last cell, in the local memory. Therefore, according to the above determination, the UE A may dispense with the process of receiving the models and directly report its own inherent AI capability to the BS, indicate that the supported models are {Model #1, Model #2}, and the corresponding execution times are t₁ₐ and t₂ₐ, respectively;
UE B does not have Model #1 and Model #2 in the local memory. The UE B preliminarily determines that it may only support Model #1 based on the indication of the BS in the operation S201 in conjunction with its own capability. Therefore, the UE B receives Model #1 in the way indicated in the operation S201, confirms the execution status of the model by executing the received model locally, and feeds back to the BS the information indicating that the UE B supports Model #1 and the execution time corresponding to Model #1 is t_{1b} together with its own inherent AI capability.

In this example, the BS indicates and transmits a model with generalization capability applicable to multiple cells through the broadcast/multicast scheme. By doing so, it may save the signaling overhead for indicating the model attribute and the resource overhead for transmitting the model, and, when the UE that already has models moves to the cell, it may shorten the preparation process of using the AI model.

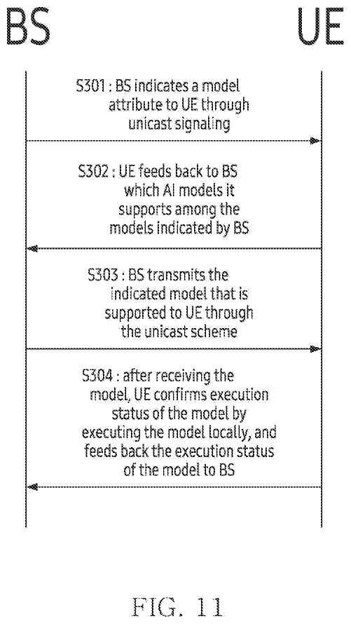

FIG. 11 is a flowchart of an example of transmitting a model by a BS to a UE according to various embodiments. This example may be suitable, for example, for a situation in which the BS wants to transmit a new model to the UE. As illustrated in FIG. 11, the model transmitter is the BS, and the model receiver is the UE. The BS transmits an AI model for CSI feedback to the UE.

In operation S301 the BS indicates a model attribute to the UE through unicast signaling. For example, the BS indicates to the UE that the models are Model Set #2 as illustrated in FIG. 6.

In operation S302, the UE feeds back to the UE which AI models it supports among the models indicated by the BS. For example, for the models indicated by the BS in the operation S301, the UE determines according to its own capability, and indicates that the supported model is {Model #3}.

In operation S303, the BS transmits the indicated model that is supported to the UE through the unicast scheme.

In operation S304, after receiving the model, the UE confirms execution status of the model by executing the model locally, and feeds back the execution status of the model to the BS. For example, the UE confirms that Model #3 is available by executing Model #3 locally, and informs the BS of an execution time t₃ₐ corresponding to Model #3.

The example described above with reference to FIG. 11 may occur, for example, in following situations: (1) when the BS intends to change the model used by the UE A after the UE A in FIG. 10 stays in one cell without switching the cell; or (2) the UE does not support all the AI models broadcasted by the BS in FIG. 10; or (3) the BS is not satisfied with the execution efficiency fed back by the UE for the example in FIG. 9. Since the UE A has already reported its own inherent AI capability to the BS in the flowcharts as illustrated in FIGS. 9 and 10, in the operation S302 in FIG. 11, the UE A only needs to feed back which AI models it supports according to the indication in the operation S301.

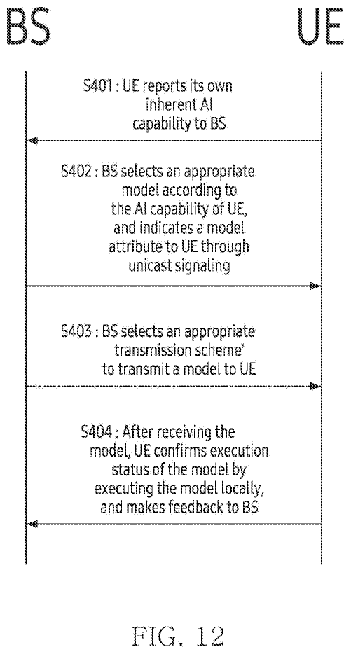

FIG. 12 is a flowchart illustrating an example of transmitting a model by a BS to a UE according to various embodiments. As illustrated in FIG. 12, the model transmitter is the BS, and the model receiver is the UE. The BS transmits an AI model for CSI feedback to the UE.

In operation S401, the UE reports its own inherent AI capability to the BS. For example, the UE reports to the BS that its own computing capability level (e.g., the FLOPS level) is 1, and it is capable of supporting deploying two models simultaneously and the like.

In operation S402, the BS selects an appropriate model according to the AI capability of the UE, and indicates a model attribute to the UE through unicast signaling. For example, the BS originally had four models as illustrated in FIG. 6, but considering that the computing capability level reported by the UE is too low, the BS chooses to indicate Model #1 and Model #3 to the UE.

In operation S403, the BS selects an appropriate transmission scheme to transmit a model to the UE. Since the operation S403 is similar to S103, the description is not repeated here.

In operation S404, after receiving the model, the UE confirms execution status of the model by executing the model locally, and makes feedback to BS. Since the operation S404 is similar to S104, the description is not repeated here.

The example described above with reference to FIG. 12 is suitable for situations including the following:
(1) When the UE updates its own inherent AI capability, if the UE does not enable an AI-related air interface capability due to factors such as user settings or electricity quantity, the UE updates and reports its own inherent AI capability so as to enable the related functionality after the user changes the setting or the electricity quantity becomes sufficient.
(2) The BS intends to know the AI capability of the UE (i.e., asking the AI capability of the UE) first, and then selects the appropriate model for indication and transmission when there are not many UEs that support receiving the AI models in the cell.

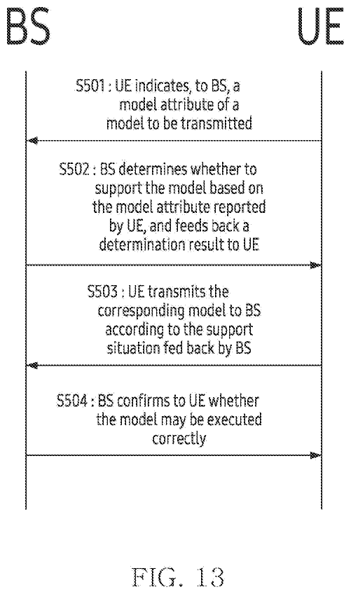

FIG. 13 is a flowchart of an example of transmitting a model by a UE to a BS according to various embodiments. This example is suitable, for example, for a situation in which a mode is transmitted from the UE to the BS. As illustrated in FIG. 13, the model transmitter is the UE, and the model receiver is the BS. The UE transmits an AI model for decoding CSI feedback to the BS.

In operation S501, the UE indicates, to the BS, a model attribute of a model to be transmitted. For example, the UE indicates Model #5 to be transmitted, to the BS through unicast signaling, and its attributes include, for example, input is CSI feedback of 48 bits, output is full channel information, FLOPs level is 3, and the like.

In operation S502, the BS determines whether to support the model based on the model attribute reported by the UE, and feeds back a determination result to the UE. For example, the BS feeds back the supporting of Model #5 to the UE.

In operation S503, the UE transmits the corresponding model to the BS according to the support situation fed back by the BS.

In operation S504, the BS confirms to the UE whether the model may be executed correctly.

The solutions related to model transmission and reception are described above in detail, and solutions related to switching of a processing approach are described below.

While switching the processing approach, a switching delay (e.g.: the time taken for preparing an AI model) required by a same UE is also different in different cases.

For example, if an AI model related to a target processing approach is smaller, a model preparation time required by the UE will be shorter.

For example, if the UE prepares the AI model related to the target processing approach in advance (for example, loading the AI model into the memory in advance, and maintaining the AI model in a state in which the AI model can be enabled at any time), when receiving switching indication information from the BS, the UE may implement switching a processing approach from a source processing approach to the target processing approach with the shorter switching delay, and even can achieve seamless switching in some cases.

For example, processing resources (computing resources, memory and/or cache resources) of the UE are limited. In some cases, the UE needs to first release the processing resources occupied by the source processing approach (for example, clearing the AI model related to the source processing approach from the memory), and then activate the target processing approach (for example, loading the AI model related to the target processing approach into the memory), This may require longer switching delay, and there will be an interruption time for the UE (that is, within the interruption time, the UE can apply neither the source processing approach nor the target processing approach).

For example, in some cases, the switching of the processing approach of one functionality will affect the processing approach of another functionality. This is because the processing resources (such as computing resources, memory and/or cache resources) of the UE are limited. When a functionality or an AI model occupies a large amount of processing resources, the processing of another functionality or AI model will be affected, that is, AI collision will occur. This is because of considering different model designs, a combination of some specific processing approaches will have compatibility issue for serially operating functionalities or modules, which will lead to performance degradation. Then, in a switching of the processing approach, it is necessary to consider processing approaches of multiple functionalities and coordinate the switching time of multiple functionalities to avoid AI collision or compatibility issues. In this case, a delay required for switching is also different.

For example, the UE cannot support multiple functionalities using AI-based processing approaches at the same time. For example, the UE not only supports an AI-based beam management functionality, but also supports an AI-based CSI feedback functionality (that is, supporting both functionalities, respectively). However, due to the limited processing resources, the UE cannot support both the beam management functionality and the CSI feedback functionality using the AI-based processing approaches at the same time.

For another example, the UE supports multiple functionalities using AI-based processing approaches at the same time, but the UE does not support specific combinations of the processing approaches of these multiple functionalities because different AI models of the same functionality have different sizes, complexity and inference time. For example, as illustrated in FIG. 14B, considering a CSI feedback functionality and a CSI prediction functionality, the UE supports AI models Model #1 and Model #2 for the CSI feedback functionality, and Model #3 and Model #4 for the CSI prediction functionality, respectively. In some application scenarios, the UE first uses an AI model for the CSI prediction functionality to deal with a problem of channel change, and then uses an AI model for the CSI feedback functionality to compress and feed back results of the CSI prediction functionality to the BS to reduce the feedback overhead. However, due to the limited processing resources, since Model #2 and Model #3 are relatively large, the UE cannot activate both models at the same time, or, since Model #2 and Model #3 have relatively high complexity, inference time for their serial processing has exceeded time requirement for reporting CSI.

For another example, the AI model for the CSI prediction functionality may be designed to infer CSI information of multiple time slots or time units in the future, that is [Wₜ₊₁, Wₜ₊₂, Wₜ₊₃, Wₜ₊₄ . . . ], and may also be designed to infer CSI information at a specific time t in the future, that is [Wₜ], where Wₜ₊ᵢ is a two-dimensional matrix about a frequency domain and a space domain. The AI model for the CSI feedback functionality may be designed to compress CSI information of three dimensions of a time domain, a frequency domain and a space domain, and may also be designed to compress CSI information of two dimensions of the frequency domain and the space domain. The AI model for the CSI prediction functionality that infers CSI information of multiple time slots or time units in the future better matches the AI model for the CSI feedback functionality that compresses CSI information of three dimensions of the time domain, the frequency domain and the space domain in the serial operation.

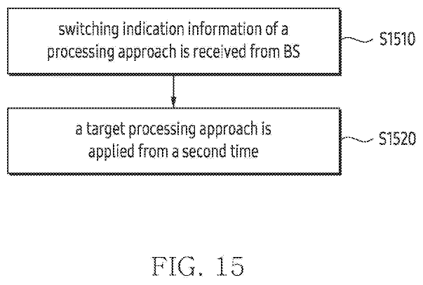

A method related to the switching of the processing approaches according to various embodiments will be described below with reference to FIG. 15.

FIG. 15 is a flowchart illustrating an example method performed by a UE according to various embodiments.

As illustrated in FIG. 15, in step S1510, switching indication information of a processing approach is received from the BS, wherein the processing approach is related to an AI model, and a time for receiving the switching indication information is a first time.

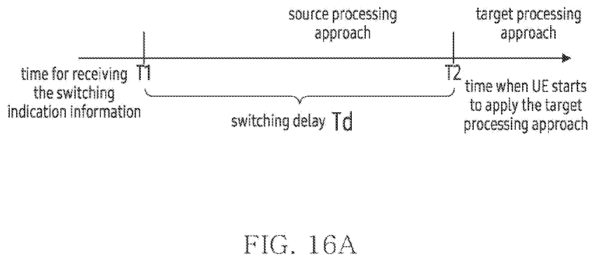

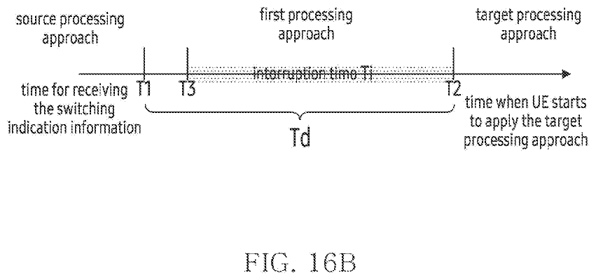

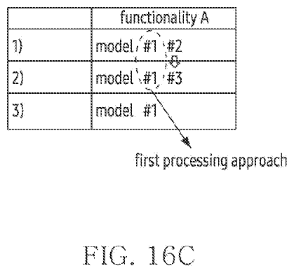

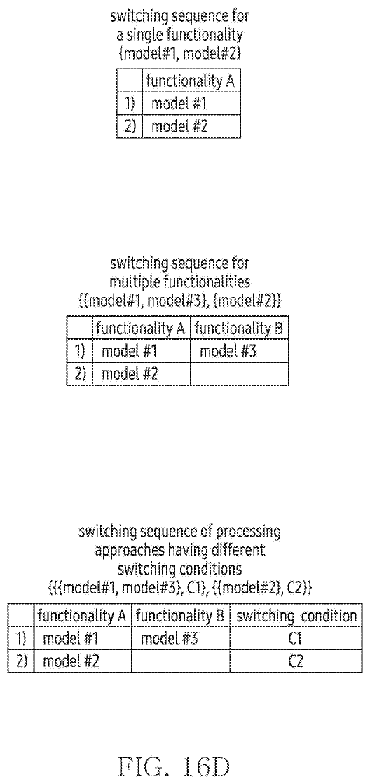

Specifically, in an example embodiment, the switching indication information may be a switching command transmitted by the BS, and the switching command may explicitly indicate to which processing approach the UE switches. The switching indication information may also be an acknowledge (ACK) from the BS to a switching request/indication transmitted by the UE. For example, the UE transmits the switching request/indication regarding the processing approach to the BS through Media Access Control (MAC)-Control Element (CE) or uplink control information (UCI), and the BS transmits the ACK to the UE to indicate the confirmation. For another example, the UE transmits an RRC message to the BS to request switching the processing approach to a certain AI model, and the BS transmits an RRC message to the UE to indicate consent and confirmation. As illustrated in FIG. 16A, T1 is the first time, that is, the time at which the switching indication information is received.

In addition, in an example embodiment, the processing approaches are related to an AI model, which may include AI model-based processing approaches and non-AI processing approaches, and the switching of the processing approaches may include switching between different AI models, and switching between the AI model-based processing approach and the non-AI processing approach.

In step S1520, a target processing approach is applied from a second time, wherein the second time is related to at least one of following items: features of the target processing approach, features of a source processing approach, or the first time.

Specifically, the features of the target processing approach and/or the source processing approach include at least one of following items: a size of an AI model(s) related to the target processing approach and/or a size of an AI model(s) related to the source processing approach; the number of the AI model(s) related to the target processing approach and/or the number of the AI model(s) related to the source processing approach; whether the target processing approach belongs to a first set; whether the source processing approach belongs to a second set; a structure(s) of the AI model(s) related to the target processing approach and/or a structure(s) of the AI model(s) related to the source processing approach; a position(s) of the target processing approach and/or the source processing approach in a first switching sequence; or the number of a functionality(s) related to the target processing approach and/or the number of a functionality(s) related to the source processing approach.

Here, the “functionality(s)” mentioned may include, but are not limited to: CSI prediction, CSI feedback, CSI enhancement, beam management, positioning, channel estimation, channel coding, channel decoding, mobility management, uplink precoder compression and recovery, beam prediction, measurement reporting, and the like.

Here, in order to make it easier to understand the technical concept of the present disclosure, the contents related to the first switching sequence are described in detail.

In the present disclosure, the first switching sequence may include different processing approaches of one functionality, or the switching sequence may include different processing approaches of multiple functionalities. This is described in detail below.

In an example embodiment, the first switching sequence may include different processing approaches of one functionality, wherein each element in the first switching sequence includes one processing approach of the functionality, wherein an AI model-based processing approach is represented by a model ID of an AI model, a model ID combination or a configuration ID, and a non-AI processing approach is represented by an empty set or a configuration ID of a non-AI approach.

For example, in a switching sequence {Model #1, Model #2, . . . , Config #1, Config #2} related to processing approaches of one functionality, the switching sequence includes both the AI model-based processing approach (such as Model #1, Model #2, Config #2) and the non-AI processing approach (such as Config #1). In this example, the AI model-based processing approach is represented by the model ID (such as Model #1) or the configuration ID (Config #2) of the AI model, and the non-AI processing approach is represented by the configuration ID (such as Config #1) of the non-AI approach.

For another example, in a switching sequence {{Model #1, Model #2}, {Model #1, Model #3}, . . . , { } } related to processing approaches of one functionality, the AI model-based processing approach is represented by the model ID combination (such as {Model #1, Model #2}), and the non-AI processing approach is represented by an empty set (that is, { }), that is to say, the processing approach of the functionality is represented by the model ID combination or the empty set. In the present disclosure, when the processing approach of one functionality is represented by the model ID combination, the functionality may, for example, be implemented by multiple AI models. For example, for the AI model-based CSI feedback functionality, Model #1 implements the CSI feedback with low precision and low bit overhead (such as broadband CSI), and Model #2 and Model #3 implement the CSI feedback with high precision and high bit overhead (such as subband CSI). Model #1 and Model #2 or Model #3 are in a parallel processing relationship. For example, for the AI model-based CSI feedback functionality, Model #1 implements feature extraction of CSI information, and Model #2 and Model #3 implement information compression with different compression rates. Model #1 and Model #2 or Model #3 are in serial processing relationship.

In an example embodiment, the first switching sequence may include different processing approaches of multiple functionalities, wherein each element in the first switching sequence includes a combination of the processing approaches of the multiple functionalities. In the first switching sequence, an AI model-based processing approach is represented by a model ID of an AI model, a model ID combination or a configuration ID, and a non-AI processing approach is represented by an empty set or a configuration ID of a non-AI approach, wherein the empty set represents that the multiple functionalities use the non-AI processing approaches respectively. When an element in the first switching sequence does not contain the model ID related to one of the multiple functionalities, the processing approach of the one functionality included in the element is a non-AI processing approach.

For example, Model #1 and Model #2 are two AI models of a functionality A, Model #3 is an AI model of a functionality B, and a switching sequence is {{Model #1, Model #3}, {Model #2}, . . . , { }}. In the switching sequence, each element includes a combination of the processing approaches of the functionality A and the functionality B. For example, as shown in a first element {Model #1, Model #3} in the switching sequence, a combination of the processing approaches of the functionality A and the functionality B is that the functionality A adopts a processing approach based on Model #1, and the functionality B adopts a processing approach based on Model #3. For another example, as shown by a second element in the switching sequence, another combination of the processing approaches of the functionality A and the functionality B is that the functionality A adopts a processing approach based on Model #2, and the functionality B adopts a non-AI processing approach. The last element in the switching sequence is an empty set, which represents that the functionality A and the functionality B both adopt non-AI processing approaches. In addition, in a case in which the model IDs of multiple functionalities do not conflict or duplicate, the empty set in the switching sequence may be removed. For example, the empty set in {{Model #1, Model #3}, {Model #2}, . . . , { }} may be removed to become {{Model #1, Model #3}, {Model #21, . . . , }. At this time, the UE may still accurately determine which function each element in the switching sequence is used for, that is, the UE may accurately determine what function each model is used for.

For another example, a switching sequence is {{Model #1}, {Model #1, Model #2}}, and the switching sequence is used for the functionality A and the functionality B. The functionality A is completed by Model #1 of the functionality A, and the functionality B is completed by Model #1 and Model #2 of the functionality B. Although both elements in the switching sequence have Model #1, Model #1 of the functionality A is different from Model #1 of the functionality B.

In addition, in the above two example embodiments, each element in the first switching sequence further includes a switching condition related to the processing approach indicated by the element. The switching condition may include, for example, at least one of following items: a switching condition based on performance, a switching condition based on applicability, or a switching condition based on usage time.

Specifically, the switching condition based on performance may, for example, include: requirements of inference performance of an AI model or processing performance of a non-AI approach (such as accuracy, precision), or requirements related to communication performance metrics (such as BLER, SINR).

The switching condition based on applicability may, for example, include: a cell or area range, an SNR range, a moving speed range, a Doppler spread range, a delay spread range, and/or the like. For example, considering complexity, some AI models are obtained by training on a specific scenario or a data set of a specific scenario. If the scenario where the AI model is applied matches it, the performance of the AI model will be better.

The switching condition based on usage time may, for example, include: usage time, the number of times of usage, and/or the like. For example, in some cases, a functionality has multiple AI models. Each AI model may be used for a period of time or a certain number of times by switching between these multiple AI models in turn, and which is optimal is determined according to the performance metrics.

In addition, in an example embodiment, the switching condition may also include one or more conditions for the source processing approach, and/or one or more conditions for the target processing approach. For example, the performance of the source processing approach is lower than a certain threshold and/or the performance of the target processing approach is higher than a certain threshold.

For example, if different AI models of a functionality are suitable for different moving speeds, in the switching sequence {{Model #1, switching condition #C1}, {Model #2, switching condition #C2}}, switching condition #C1 and switching condition #C2 may indicate different moving speed ranges. In the present disclosure, a configuration ID related to the switching condition (such as C1 and C2 in FIG. 16D) may be used to indicate the switching condition. For example, as illustrated in FIG. 16D, when the switching condition C2 is satisfied, it may switch from {Model #1, Model #3} to {Model #2}.

In addition, in an example embodiment, a sorted order of the elements in the first switching sequence is determined based on at least one of items including: an order indicated by a base station; a preset order; or features of a processing approach. The features of the processing approach are designated by the BS or preset. The features of the processing approach may include, for example, at least one of following items: a size of an AI model(s) related to the processing approach; the number of the AI model(s) related to the processing approach; a complexity of the AI model(s) related to the processing approach; or an applicable condition of the processing approach. The applicable condition of the processing approach includes, for example, at least one of following items: a cell range, an SNR range, a moving speed, a Doppler spread range, or a delay spread range.

Specifically, for example, the BS may indicate that the elements in the switching sequence are sorted from low to high according to the magnitude of the moving speed for which the processing approach is suitable. For another example, the complexity of an AI model has a close relationship with its generalization capability. Specifically, for the same functionality, AI models with high complexity generally have good generalization performance, but high complexity often means that the overhead of the UE is high. In some application scenarios, the BS indicates that the elements in the switching sequence are sorted according to the complexity of the processing approach (such as, the Floating Point Of Operations (FLOPs) value or FLOPs level of the related model). When the two processing approaches have the same complexity, their relative order is decided by the preset order or the order indicated by the base station. In this way, the UE may first apply the processing approach with low complexity, and if the performance does not meet the requirements, the UE then switches to the processing approach with higher complexity. Similarly, the cell range to which the processing approach is applicable is also related to its generalization performance or complexity. Generally, the larger the applicable cell range (the range may be measured according to the number of applicable cells), the better the generalization performance and the higher the complexity.

Furthermore, the sorted order of the respective elements in the switching sequence may actually reflect the relationship between the processing approaches. The switching of the processing approach is not completely random, and there is a certain correlation between the target processing approach and the source processing approach. In some cases, this correlation is predictable. For example, considering the power consumption overhead of the UE running AI models, the UE may preferentially try low complexity or small AI models. When the performance fails to meet the requirements and thus the processing approach is switched, the target processing approach may be a processing approach having higher complexity or a larger AI model than the source processing approach. In other cases, a switching probability between some processing approaches may be counted. For example, if Model #1 of the functionality A is an AI model applicable to indoor scenarios, then, when the UE moves or the environment changes, the processing approach of the functionality A will be switched to the model Model #2 with better generalization performance with high probability (for example, it is applicable to indoor scenarios as well as outdoor scenarios) to obtain better performance. The BS may configure the switching sequence in advance according to this statistical relationship. In addition, from a perspective of specific users, whether there is a high probability of high speed movement after the users move or the environment changes may further be analyzed according to their behavior pattern features, so as to configure the corresponding switching sequence in advance.

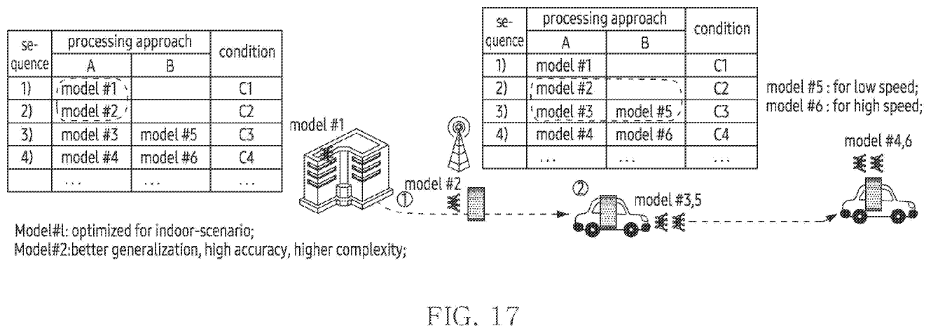

For example, FIG. 17 illustrates such a scenario. Considering two functionalities A and B in a UE, the functionality A is a CSI feedback functionality, the functionality B is a CSI prediction functionality, the UE moves from the inside of a building to the outside of the building, then enters an automobile, and travels with the automobile quickly. In this scenario, when the UE is located inside the building, as illustrated in FIG. 17, Model #1 is more suitable for indoor scenarios, and a combination of the processing approaches of the functionality A and functionality B is {Model #1}; when the UE moves from the inside of the building to the outside of the building, since Model #2 has better generalization, higher accuracy and higher complexity, at this time, the combination of the processing approaches of the functionality A and functionality B is switched from {Model #1} to {Model #2}; when the UE enters the automobile and starts traveling, since a traveling speed of the automobile is slow at the moment and Model #5 is suitable for slow-speed moving, the combination of the processing approaches of the functionality A and functionality B is switched from {Model #2} to {Model #3, Model #5}; when the automobile travels quickly, since Model #6 is suitable for high-speed moving, the combination of the processing approaches of the functionality A and functionality B is switched from {Model #3, Model #5} to {Model #4, Model #6}. In this example, when the UE is inside the building, the UE may prepare the model Model #2 in advance (that is, the next model of the current model Model #1). When the BS transmits the switching indication information to indicate the UE to switch to the model Model #2, since the UE has already prepared the model Model #2, this can reduce the switching delay. When the UE switches the processing approach of the CSI prediction functionality (for example, switching to Model #5) due to the movement, the UE will synchronously switch the processing approach regarding the CSI feedback functionality (for example, switching to Model #3). In this example, the reason for synchronous switching is that there is no combination {Model #2, Model #5} or {Model #3} in the switching sequence. There may be many reasons, for example, the UE may not support such a combination of the processing approaches, or these combinations have compatibility issues for serial operation, so that the UE needs to perform synchronous switching for the processing approaches of the functionality A and functionality B.

To sum up, the switching sequence may be used, for example, for the following two purposes:
1. the UE can prepare the AI model in advance according to the information provided by the switching sequence to thereby reduce the switching delay. Specifically, the switching sequence provides the UE with candidate target processing approaches, switching order and switching conditions, so that the UE may prepare for the switching of the processing approach in advance according to these information, for example, loading the most likely target AI model into the memory in advance, so as to shorten the switching delay.
2. the UE can avoid the AI collision/compatibility issue according to the information provided by the switching sequence. Specifically, the UE may determine the processing approaches of multiple functionalities based on the switching sequence, and thus avoid the switching collision and compatibility issues of the processing approaches.

Various methods for determining the second time will be described in detail below.

In the following methods, T2=T1+Td, where Td is the switching delay, T2 is the second time, and T1 is the first time. Td may be determined, for example, according to the following methods, and further T2 is determined.

(1) Method 1:

In an example embodiment, the switching delay Td may be determined according a following equation (1):

$$Td = \{ \begin{matrix}Th\_Td \_ 1 , & condition x is satisfied \\ Th\_Td \_ 2 , & other\end{matrix} \begin{matrix} \\ \end{matrix} \qquad ( 1 )$$

As illustrated in FIG. 16A, the UE starts to apply the target processing approach at time T2 (=T1+Td); Th_Td_1 and Th_Td_2 may be preset, set by the BS, or determined according to the capability of the UE, and Th_Td_2>Th_Td_1.

In addition, condition x may include, for example, at least one of following items: a size of an AI model(s) related to the target processing approach is less than a threshold A; a size of an AI model(s) related to the source processing approach is less than a threshold B; the target processing approach belongs to a first set; the source processing approach belongs to a second set; the structure(s) of the AI model(s) related to the source processing approach is same as the structure(s) of the AI model(s) related to the target processing approach; or a position(s) of the target processing approach and/or the source processing approach in a first switching sequence satisfies/satisfy condition y. Each item that may be included in condition x is described in detail below.

In the present disclosure, the size of the AI model(s) is related to at least one of following items, for example: a storage size of one model itself; a memory overhead required for instantiating one model; a memory overhead required for running or applying one model; or a computing resource overhead when running or applying one model. In addition, various thresholds mentioned in the present disclosure (for example, the above-mentioned threshold A and threshold B, and for another example, the first threshold to the eighth threshold to be mentioned below) may be preset, set by the BS, or determined according to the capability of the UE. In addition, some of the various thresholds mentioned in the present disclosure may be the same or different, and are not specifically limited by the present disclosure.

In the present disclosure, the first set and/or the second set may be indicated by the BS or preset. For example, the first set and/or the second set may be default processing approaches of one or more functionalities indicated by the BS. The processing approaches in the set(s) may be the AI model-based processing approaches, or may be the non-AI processing approaches. In addition, the processing approach in the set(s) may use separately reserved or dedicated computing resources and/or storage resources, so that the UE may perform relatively simple processing on computing resources and/or storage resources, or may process them in parallel while performing the switching of the processing approach. Thus, the required switching processing time may be shorter.

In the present disclosure, when the structure(s) of the AI model(s) related to the source processing approach is the same as that of the AI model(s) related to the target processing approach, an implementation of the switching of the processing approach may be to update weights of the existing model instance(s) (such as the instance(s) of the AI model(s) related to the source processing approach), instead of creating a model instance(s) (such as the instance(s) of the AI model(s) related to the target processing approach) all over again. In this way, the UE may apply the target processing approach faster.

In the present disclosure, with respect to a position(s) of the target processing approach and/or the source processing approach in the first switching sequence satisfying condition y, the condition y may include, for example, at least one of following items: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy switching conditions and are adjacent to the source processing approach in the first switching sequence; the target processing approach is one of first N5 processing approaches in the first switching sequence; the target processing approach is one of first N6 processing approaches that satisfy switching conditions in the first switching sequence; and the target processing approach is one of N7 processing approaches selected to be reported by the UE from the first switching sequence. At least one of N1 to N7 is preset, set by the BS, determined according to the capability of the UE, or the number related to the size of the AI model. For example, for Nn in N1 to N7 (where n is one of 1 to 7), it is assumed that Nn is the number related to the size of the AI model. Nn is the largest integer satisfying a following equation:

Σᵢ₌₁^{i=Nn}Msizeᵢ<Th_preparedModelsize_Nn (2)

where Msizeᵢ denotes a size of an AI model(s) related to the ith processing approach in the Nn processing approaches, Th_preparedModelsize_Nn denotes a threshold related to Nn, that is to say, each Nn has a corresponding threshold Th_preparedModelsize_Nn, and the threshold Th_preparedModelsize_Nn may be preset, set by the BS or determined according to the capability of the UE. In other words, Nn is a maximum integer when the sum of the sizes of AI models related to the Nn processing approaches does not exceed the corresponding threshold Th_preparedModelsize_Nn. In addition, some or all of N1 to N7 may be the same or different.

For example, as for the case in which the target processing approach is one of the N1 processing approaches located after the source processing approach in the first switching sequence, the UE has prepared an AI model(s) related to the N1 processing approaches in advance, so that the switching delay is shorter. However, in view of the limited resources of the UE for the preparation operation in advance, a size of N1 is determined using this limit (i.e., the threshold Th_preparedModelsize_N1). For example, when the limit is 50M (that is, when the threshold Th_preparedModelsize_N1 is 50M), N1 is the maximum integer satisfying Σᵢ₌₁^{i=N}1 Msizeᵢ≤50M, where, Msizeᵢ represents the size of an AI model(s) related to the ith processing approach of the N1 processing approaches located after the source processing approach in the first switching sequence. The size of N1 may be determined by the calculation process.

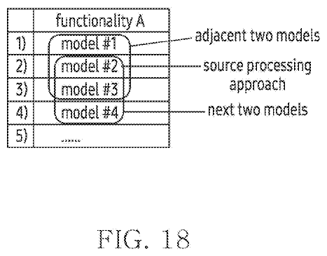

In an example embodiment, for example, the switching sequence is sorted based on the complexity of the AI model. As illustrated in FIG. 18, the source processing approach of the UE is Model #2. The target processing approach may be two processing approaches (i.e., Model #3 and Model #4) located after the source processing approach in the switching sequence, or the target processing approach may be one processing approach (i.e., Model #3) which satisfies a switching condition and is located after the source processing approach in the switching sequence, or the target processing approach may be two processing approaches (i.e., Model #1 and Model #3) adjacent to the source processing approach in the switching sequence, or the target processing approach may be one processing approach (i.e., Model #1) that satisfies a switching condition and is adjacent to the source processing approach in the switching sequence.

For another example, as illustrated in FIG. 18, the source processing approach of the UE is Model #2. The UE prepares the processing approach (i.e., Model #3) next to Model #2 in advance based on the order shown in the switching sequence. In this way, when the performance degrades so as to trigger the switching of the processing approach, if the target processing approach indicated by the BS is Model #3, the UE will apply Model #3 faster at T2=T1+Th_Td_1 since the UE has prepared Model #3 in advance. If the target processing approach indicated by the BS is Model #4, since the UE does not prepare Model #4 in advance, the UE requires longer switching processing time, and the UE will apply Model #4 at T2=T1+Th_Td_2.

In addition, the first switching sequence may, for example, be associated with at least one of following items: a switching sequence indicated by a base station; a switching sequence reported by the UE; or a preset switching sequence.

Specifically, in an example embodiment, the first switching sequence is determined based on the switching sequence indicated by the base station and the switching sequence reported by the UE, wherein the switching sequence reported by the UE is the last switching sequence reported by the UE after the base station indicates the switching sequence. In this case, the elements of the first switching sequence are the elements in both the switching sequence indicated by the base station and the switching sequence reported by the UE. In other words, the UE may ignore the elements (the processing approaches/the combinations of the processing approaches) that are not included in the switching sequence reported by the UE. The BS should not indicate that the UE applies the processing approaches or the combinations of the processing approaches that are not included in the switching sequence reported by UE.

For example, if the switching sequence indicated by the BS is {Model #1, Model #2, Model #3}, and the switching sequence reported by the UE is {Model #1, Model #3, Model #5}, then the first switching sequence is {Model #1, Model #3}.

For another example, the switching sequence indicated by the BS is {{Model #1, Model #3}, {Model #2, Model #3}, {Model #1, Model #4}, {Model #2}}, and the switching sequence reported by the UE is {{Model #2}, {Model #1, Model #4}, {Model #1, Model #3}}, then the first switching sequence is {{Model #1, Model #3}, {Model #1, Model #4}, {Model #2}}.

In the present disclosure, it is considered that the UE will not only apply the AI models indicated by the BS, but also apply AI models not known by the BS, and the influence of operating temperature on the operation performance of the UE is also considered. These factors will lead to the dynamic change of the support capability and the computing capability of the UE for AI models. In the above solution, after the UE reports the switching sequence successfully, the first switching sequence will immediately exclude those processing approaches or combinations of the processing approaches that are not supported by the UE, so as to quickly adjust the first switching sequence based on the dynamically changed AI processing capability of the UE. Moreover, the UE may provide the BS with assistance information for model switching by reporting switching sequences containing different elements or having different orders. For example, the UE recommends to the BS a switching sequence that is more suitable for its own behavior pattern features based on its own determination or prediction.

In addition, the first switching sequence may be further updated by the above methods to avoid AI collision or compatibility issues, in addition to coordinating the switching for multiple functionalities by including different processing approaches of multiple functionalities to avoid AI collision or compatibility issues. For example, as illustrated in FIG. 14B, the functionality A and the functionality B have respective first switching sequences. The first switching sequence of the functionality A is {Model #1, Model #2, { }}, and the first switching sequence of the functionality B is {Model #4, Model #3, { }}, wherein the UE cannot apply or activate Model #2 and Model #3 simultaneously. Assuming that the functionality B applies Model #4, when the functionality A switches to Model #2, the UE may report the switching sequence {Model #4, { }} to update the first switching sequence in time, so as to avoid AI model collision or compatibility issues further caused by the functionality B switching to Model #3.

In addition, in an example embodiment, the last element of the first switching sequence is a non-AI processing approach of the corresponding function by default, or the default processing approach designated by the BS, or the preset processing approach. For example, the BS indicates that the switching sequence is {Model #1, Model #2, Model #3}, and the first switching sequence is {Model #1, Model #2, Model #3, { }}. This can save the signaling overhead for indicating the switching sequence.

(2) Method 2

In another example embodiment, the switching delay Td may be determined according following equation (3):

Td=min(α_{target}*Msize_{target}+α_{source}*Msize_{source},Tdₗᵢₘᵢₜₐₜᵢₒₙ) (3)

where Msize_{target} denotes a size of an AI model(s) related to the target processing approach; Msize_{source} denotes a size of an AI model(s) related to the source processing approach; α_{target} and α_{source} denote preset scaling coefficients, which may be preset, set by the BS, or determined according to the capability of the UE, and α_{target}≥0, α_{source}≥0; α_{source}*Msize_{source} denotes time required for processing the resources occupied by the source processing approach. For example, time required for releasing the resources occupied by the source processing approach; and α_{target}*Msize_{target} denotes time required for preparing the target processing approach. For example, if the target processing approach is an AI model-based processing approach, the time required for preparing the target processing approach (i.e., α_{target}*Msize_{target}) may be time required by operations of converting an AI model(s) into a UE-specific executable format(s), loading parameters related to the AI model(s) into the memory, instantiating the AI model(s) and the like. Tdₗᵢₘᵢₜₐₜᵢₒₙ denotes an upper limit of the switching delay, which may be preset, set by the BS, or determined according to the capability of the UE. min( ) denotes a minimum value.

In the present disclosure, when the AI model(s) related to the target processing approach include multiple AI models, as an alternative method, Msize_{target} represents a sum of the sizes of multiple AI models related to the target processing approach, that is, Msize_{target}=Σᵢ Msize_{target}_{ᵢ}, where, Msize_{target} represents a size of the ith AI model related to the target processing approach, and Σ represents summation. This alternative method can be applicable, for example, to the situation in which the UE may only serially prepare the AI models related to the target processing approach. When the AI model(s) related to the target processing approach include multiple AI models, as an another alternative method, Msize_{target} represents a maximum value of the sizes of the multiple AI models related to the target processing approach. That is, Msize_{target}=max({Msize_{target}_{ᵢ}}), max( ) represents the maximum value, and {Msize_{target}_{ᵢ}} represents a set of the sizes of the multiple AI models related to the target processing approach. The alternative method may be applicable, for example, to a situation in which the UE may prepare the AI models related to the target processing approach in parallel. In addition, as for the case where the AI model(s) related to the source processing approach includes multiple AI models, a similar method may be adopted, which will not be repeated here.

(3) Method 3

In another example embodiment, the switching delay Td may be determined according to following equation (4):

Td=min(β_{target}*Mnum_{target}+β_{source}*Mnum_{source}+α_{target}*Msize_{target}+α_{source}*Msize_{source},Tdₗᵢₘᵢₜₐₜᵢₒₙ) (4)

where Mnum_{target} denotes the number of an AI model(s) related to the target processing approach; Mnum_{source} denotes the number of an AI model(s) related to the source processing approach; β_{target}, α_{target}, β_{source} and α_{source} denote preset scaling coefficients, which may be preset, set by the BS, or determined according to the capability of the UE, and β_{target}≥0, α_{target}≥0, β_{source}≥0 and α_{source}≥0. Compared with equation (3), equation (4) directly considers the number of the AI model(s) related to the target processing approach and/or the number of the AI model(s) related to the source processing approach. For example, Msize_{target}=max({Msize_{target}})). That is, the UE prepares the AI model(s) related to the target processing approach in parallel, selects processing time of the AI model with a maximum size as a reference, and adds a time margin R_{target}*Mnum_{target} for processing multiple AI models related to the target processing approach on this basis. Similarly, the same is true for the source processing approach, which will not repeated here.

(4) Method 4

In other example embodiments, the switching delay Td may be determined according to synthesis of at least two of the above equations (1), (3) and (4). For example, the switching delay Td may be determined by using following equation (5) based on the synthesis of equations (1) and (3):

$$Td = \{ \begin{matrix}\begin{matrix}min ( {α1}_{target} * M {size}_{target} + \\ α {1}_{s o u r c e} * M {size}_{s o u r c e} , T {d}_{limitation} ) ,\end{matrix} & condition x is satisfied \\ \begin{matrix}min ( {α2}_{target} * M {size}_{target} + \\ α {2}_{s o u r c e} * M {size}_{s o u r c e} , T {d}_{limitation} ) ,\end{matrix} & other\end{matrix} \qquad ( 5 )$$

Where α2_{target}>α1_{target}≥0, α2_{source}>α1_{source}≥0, and α2_{target}, α1_{target}, α2_{source} [symbol] α1_{source} may be preset, set by the BS, or determined according to the capability of the UE.

For example, according to equation (5), the influence factors of the size of the model may be further considered on the basis of considering whether the structure(s) of the AI model(s) related to the source processing approach is the same as that of the AI model(s) related to the target processing approach.

The various methods for determining the switching delay Td are listed above by way of example, but the present disclosure is not limited thereto. For example, any method that may determine the switching delay Td according to different syntheses of the above equations (1), (3) and (4) may be applied to the present disclosure.

In addition, in the present disclosure, the unit of time may be millisecond ms, or may another preset time unit, such as slot. Therefore, in the various methods described above, it is also possible to uniformly process the time unit of Td. For example, when Td is determined to be α_{target}*Msize_{target}+α_{source}*Msize_{source} according to equation (3), and the time unit of T2 is the slot, time unit processing may be performed on the unit of Td according to following equation (6):

$$T d = \frac{{α}_{target} * M {size}_{target} + {α}_{source} * M {size}_{s o u r c e}}{h} \qquad ( 6 )$$

where h denotes a slot length.

Determining the switching delay Td by various methods described above may effectively reduce the switching delay.

In addition, the method performed by the UE may, for example further include deactivating the source processing approach at a third time when a first condition is satisfied, wherein the third time is before the second time.

Specifically, the first condition may include, for example, at least one of following items: a size of an AI model(s) related to the source processing approach is not less than a first threshold and/or a size of an AI model(s) related to the target processing approach is not less than a second threshold; a sum of the size of the AI model(s) related to the source processing approach and/or the size of the AI model(s) related to the target processing approach is not less than a third threshold; a processing source of the UE already occupied at the first time is not less than a fourth threshold and/or the size of the AI model(s) related to the target processing approach is not less than a fifth threshold; the structure(s) of the AI model(s) related to the source processing approach is same as the structure(s) of the AI model(s) related to the target processing approach; a related performance parameter value of the source processing approach is not greater than a sixth threshold; or a difference value between the second time and the first time is not less than a seventh threshold. In the present disclosure, processing resources may refer, for example, to memory or cache resources and computing resources. In an example embodiment, the processing resources that have been occupied are for a certain type of processing approach, such as, the processing resources that have been occupied by the AI model-based processing approach.

In an example embodiment, when the size of the AI model(s) related to the source processing approach is not less than the first threshold (that is, the AI models related to the source processing approach occupy more memory resources), and/or the size of the AI model(s) related to the target processing approach is not less than the second threshold (that is, the AI model(s) related to the target processing approach requires more memory overhead), or, when the sum of the size of the AI model(s) related to the source processing approach and the size of the AI model(s) related to the target processing approach is not less than the third threshold, this means that due to the UE being limited by the processing capability, the UE cannot activate the AI model(s) related to the target processing approach first (for example, cannot load the AI model(s) related to the target processing approach into the memory first), and then deactivate the AI model(s) related to the source processing approach. In this case, the UE can only deactivate the source processing approach (for example, releasing the processing resources occupied by the source processing approach, and clearing the source AI model(s) from the memory) first, and then activate and apply the target processing approach. Therefore, as illustrated in FIG. 16B, the UE may deactivate the source processing approach at the third time T3 before the second time T2, and then start to apply the target processing approach from the second time T2.

For example, the UE switches the AI model regarding the CSI feedback functionality from Model #1 (the size is 20M) to Model #2 (the size is 40M), but the size of Model #1 is not less than the first threshold (the size is 18M, for example), and the size of Model #2 is not less than the second threshold (the size is 35M, for example). Or, in the AI processing resources allocated for the CSI feedback functionality, the limit of a memory space is 50M, that is, the third threshold is 50M. It can be seen that the sum of the sizes of the two models Model #1 and Model #2 (that is, 60M) is not less than the third threshold (that is, not less than the limit of the memory space). Therefore, the UE cannot maintain Model #1 and Model #2 in the memory at the same time. The UE can only deactivate Model #1 first and then load Model #2.

In the above description, the limit for the processing resources is with respect to one functionality, that is, is functionality-specific. However, the present disclosure is not limited thereto. The limit for the processing resources may also be with respect to the UE. For example, with respect to the processing resources that the UE has occupied (such as the memory or cache resources), or the limit for the processing resources is with respect to a certain type of processing approaches of the UE, for example, with respect to all the AI models in the UE, in other words, is UE-specific.

Specifically, when the processing resources (such as the memory or cache resources) occupied by the UE at the first time are not less than the fourth threshold, and/or the size of the AI model(s) related to the target processing approach is not less than the fifth threshold, the UE also needs to deactivate the AI model(s) related to the source processing approach first, and then apply the AI model(s) related to the target processing approach. Therefore, in this case, the UE may deactivate the source processing approach at the third time T3 before the second time T2, and then start to apply the target processing approach from the second time T2.

For example, in an example embodiment, the occupied processing resources are distinguished according to the type of the processing approach, for example, distinguished as the processing resources that have been occupied by the AI model-based processing approach, and the processing resources that have been occupied by the non-AI processing approach. For example, the total memory in AI processing resources of the UE is limited to 200M, but 170M of memory resources of the UE is already occupied by the AI-based processing approach at the first time. When the UE needs to switch the AI model regarding the CSI feedback functionality from Model #1 (the size is 20M) to Model #2 (the size is 40M), since the memory resources of the UE occupied by the AI-based processing approach at the first time (i.e., 170M) are not less than the fourth threshold (e.g., 165M), and/or the size of Model #2 is greater than the fifth threshold (e.g., 38M), the UE first deactivates Model #1, releases the memory space, then loads Model #2 into the memory, activates and applies Model #2.

Similarly, in an example embodiment, the occupied processing resources are not distinguished for the types of the processing approaches that occupy the processing resources. That is to say, the processing approaches that occupy the processing resources may include the AI-based processing approaches and/or the non-AI processing approaches. For example, the total memory in processing resources of the UE is limited to 200M, but 170M of memory resources of the UE is occupied at the first time. When the UE needs to switch the AI model regarding the CSI feedback functionality from Model #1 (the size is 20M) to Model #2 (the size is 40M), since the memory resources of the UE occupied at the first time (i.e., 170M) are not less than the fourth threshold (e.g., 165M), and/or the size of Model #2 is greater than the fifth threshold (e.g., 38M), the UE first deactivates Model #1, releases the memory space, then loads Model #2 into the memory, activates and applies Model #2.

In an example embodiment, when the structure(s) of the AI model(s) related to the source processing approach is the same as that of the AI model(s) related to the target processing approach, an implementation of the switching of the processing approach is to update weights of the existing model instance(s) (such as the instance(s) of the AI model(s) related to the source processing approach), instead of creating a model instance(s) (such as the instance(s) of the AI model(s) related to the target processing approach) all over again. The overall delay of this switching method will be shortened. Thus, in this case, the UE may first deactivate the source processing approach at the third time T3 before the second time T2, and then start to apply the target processing approach from the second time T2.

In another example embodiment, the UE supports seamless switching between the source processing approach and the target processing approach. For example, the UE first activates the target processing approach and then deactivates the source processing approach. However, if the performance related parameter value of the source processing approach is already lower than the sixth threshold at or before the first time, continuing to use the source processing approach may cause further degradation of the communication performance. In this case, the UE may first deactivate the source processing approach at the third time T3 before the second time T2, and then start to apply the target processing approach from the second time T2. The performance related parameter values of the source processing approach refer to, for example, the accuracy, the precision, or the final communication performance metrics (such as BLER, SINR) of the source processing approach, but the present disclosure is not limited hereto. The sixth threshold may be related to the performance of the default processing approach or non-AI processing approach, or may also be set by the BS, preset, or determined according to the capability of the UE.

In an example embodiment, if a difference between the second time at which the UE starts to apply the target processing approach and the first time is not less than the seventh threshold (that is, the UE requires longer processing time to start to apply the target processing approach), then after the UE receives the switching indication information, the UE may first deactivate the source processing approach at the third time T3 before the second time T2, then start to apply the target processing approach from the second time T2.

In addition, the method performed by the UE may further include, for example, applying a first processing approach between the third time to the second time.

Specifically, in some cases, as for the functionality of which the processing approach is switched, the execution of the functionality needs to be continued within the interruption time (i.e., Ti between the third time and the second time as shown in FIG. 16B). However, within the interruption time, the UE may apply neither the source processing approach nor the target processing approach, and the UE may apply the first processing approach indicated by the base station or preset to process the functionality.

In an example embodiment, the first processing approach may be a non-AI processing approach.

In an example embodiment, the first processing approach may be an AI model-based processing approach. For example, the AI model related to the first processing approach may be the AI model that has been deployed or activated by the corresponding functionality. Then the UE may seamlessly switch to the AI model at the third time T3, and the switching delay is shorter. In the present disclosure, “deployed” refers to, for example, the processing approach occupying the processing resources of the UE, for example, occupying the memory or cache resources of the UE and/or the computing resources of the UE. For another example, the AI model related to the first processing approach is a default model specified by the BS or preset. These models use reserved or dedicated computing resources and/or storage resources. The UE may seamlessly switch to this AI model at the third time T3, and the switching delay is shorter.

For example, as for the case in which the AI model related to the first processing approach is the AI model that has been deployed or activated by the corresponding functionality, in some cases, the same functionality may apply, deploy or activate multiple AI models. For example, as illustrated in FIG. 16C, it is assumed that the CSI feedback functionality has three available AI models (i.e., Model #1, Model #2, Model #3), and Model #1 is an AI model with good generalization performance and low precision, Model #2 and Model #3 are AI models that have been optimized for different specific scenarios and have high precision (that is, Model #2 and Model #3 will have better performance than Model #1, but less generalization performance than Model #1 in the specific scenario). The CSI feedback function may apply the processing approach {Model #1, Model #2} or {Model #1, Model #3}, that is, apply a model with good generalization performance and a model that has been optimized for a specific scenario at the same time. The BS may configure and schedule feedbacks based on both models, respectively, and comprehensively consider and select appropriate downlink precoder. The BS may indicate that Model #1 is the default model of the CSI feedback function (i.e., the first processing approach). When the UE switches from the processing approach {Model #1, Model #2} to {Model #1, Model #3}, it is assumed that the UE needs to deactivate Model #2 at T3 first, and then apply Model #3 at T2. The CSI reporting operation originally processed by Model #2 is completed by Model #1, within the interruption time (i.e., T3 to T2).

In addition, the third time is related, for example, to at least one of following items: features of the first processing approach, features of the source processing approach, or the first time.

Specifically, similar to the features of the target processing approach and the features of the source processing approach, the features of the first processing approach include, for example, at least one of following items: a size of an AI model(s) related to the first processing approach; the number of AI model(s) related to the first processing approach; whether the first processing approach belongs to a first set; a structure(s) of the AI model(s) related to the first processing approach; a position of the first processing approach in a first switching sequence; or the number of a functionality(s) related to the first processing approach.

Specifically, T3=T1+T_{fb} where, T_{fb} is the first delay, that is, a time difference between the third time and the first time. T_{fb} may be preset, set by the BS, or determined according to the capability of the UE. In this case, T3 is related to the first time T1. In addition, T_{fb} may also be related to the features of the first processing approach, and, in this case, T3 is related to the first time T1 and the features of the first processing approach.

For example, the first delay T_{fb} may be determined according to following equation (7):

$${T}_{fb} = \{ \begin{matrix}{Δ}_{t 1} , & condition z is satisfied \\ {Δ}_{t 2} , & other\end{matrix} \begin{matrix} \\ \end{matrix} \qquad ( 7 )$$

where Δₜ₁ and Δₜ₂ may be preset, set by the BS, or determined according to the capability of the UE, and Δₜ₂>Δₜ₁. Condition z may include, for example, at least one of following items: the first processing approach is a non-AI processing approach or the AI model attribute related to the first processing approach belongs to a set indicated by the base station or preset.

In addition, in any of the methods for determining the switching delay Td involved in the above description of the step S1520, if the features of the target processing approach used in these methods are replaced with the features of the first processing approach, these methods may be used to determine the first delay T_{fb}. Since these methods have been described in detail above, this description will not be repeated here.

By deactivating the source processing approach at the third time T3 and applying the first processing approach within the interruption time between the third time and the second time, the fast switching of the processing approach within the interruption time may be realized.

In addition, the above method performed by the UE may, for example, further include determining the target processing approach related to multiple functionalities. The target processing approach is a combination of processing approaches of the multiple functionalities and the target processing approach is related to at least one of following items: the switching indication information, or the first switching sequence.

Specifically, in an example embodiment, the determining of the target processing approach related to multiple functionalities may, for example, include: when the switching indication information received from the BS is related to a position number of an element in the first switching sequence, the UE may determine the target processing approaches related to the multiple functionalities according to the corresponding element in the first switching sequence.

In an example embodiment, the determining of the target processing approach related to multiple functionalities may, for example, include: when the switching indication information received from the BS only includes a first target processing approach related to a first functionality, determining a second target processing approach related to a second functionality according to the first target processing approach and the first switching sequence, wherein the second functionality refers to another functionality other than the first functionality among the functionalities related to the first switching sequence.

Specifically, the determining of the second target processing approach related to the second functionality according to the first target processing approach and the first switching sequence may, for example, include at least one of following items: when the element containing both of the processing approach of the second functionality at the first time and the first target processing approach does not exist in the first switching sequence, the second target processing approach is a corresponding processing approach of the second functionality indicated by a first element including the first target processing approach in the first switching sequence, thereby avoiding the collision and/or compatibility issues through linkage switching; and when a fourth condition is satisfied, the second target processing approach is a second processing approach, wherein the second processing approach is a processing approach of the second functionality indicated by signaling for the last time, wherein the fourth condition is that an element including both of the second processing approach and the first target processing approach exists in the first switching sequence, so that the second functionality may quickly recover from the linkage switching. An example scenario is that the second functionality is downgraded in linkage because a functionality with higher priority occupies the AI processing resources, and the method may enable the second functionality to be recovered from the linkage downgradation to the preferred processing approach quickly.

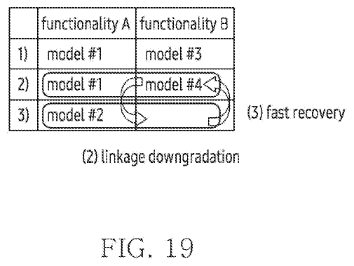

For example, as in the switching sequence illustrated in FIG. 19, the functionality A corresponding to Model #1 and Model #2 is the CSI feedback functionality, and the functionality B corresponding to Model #3 and Model #4 is the CSI prediction functionality. Varying degrees of reduction in the reference signal overhead may be achieved based on different AI models (Model #3 and Model #4) for the CSI prediction functionality. Model #1 is an AI model (i.e., CSI feedback model) that is more suitable for cooperation with the CSI prediction functionality. Model #2 is used for the CSI compression feedback functionality with high precision. In consideration of the compatibility or the problem of UE capability, Model #2 may not be used with Model #3 or Model #4. To ensure performance, in some application scenarios, the BS will intermittently instruct the UE to switch to {Model #2} (that is, the CSI feedback functionality applies Model #2, and the CSI prediction functionality applies a non-AI processing approach) to obtain accurate CSI information. For example:
(1) the BS first instructs the UE to apply Model #1 to process CSI feedback and apply Model #4 for CSI prediction. The indication may also be indicated based on the position number of the element in the switching sequence, for example, indicating to apply the processing approach indicated by the second element in the switching sequence, that is, the UE applies such a combination of the processing approaches, {Model #1, Model #4}.
(2) the BS transmits the switch command to instruct the UE to switch the AI model for the CSI feedback functionality to Model #2. Since such a combination of the processing approaches, i.e, Model #4 for the CSI prediction functionality and target model Model #2 for the CSI feedback functionality, is not in the switching sequence when the switching command is received, the UE determines the target processing approach of the CSI prediction functionality according to the processing approach of the CSI prediction functionality (i.e., the non-AI processing approach) indicated by a first element containing Model #2 (i.e. the third element) in the switching sequence. Alternatively, another method is that the BS directly indicates to apply the processing approach indicated by the third element in the switching sequence. Also, if the two functionalities perform asynchronous switching, there will be a combination of processing approaches that is not in the switching sequence. For example, in this example, it is assumed that the CSI prediction functionality switching from the source processing approach to the non-AI processing approach is faster than the switching of the CSI feedback functionality. There will be a such a processing approach combination{Model #1}, that is, the CSI feedback functionality uses Model #1, and the CSI prediction functionality uses the non-AI processing approach. However, this processing approach combination is not in the switching sequence, so the UE synchronously switches the processing approach of the CSI prediction functionality to the non-AI processing approach while switching the AI model of the CSI feedback functionality. Thus, AI collision and/or compatibility problems between multiple functions may be avoided through linkage switching.
(3) the BS transmits the switch command to instruct the UE to switch the AI model for the CSI feedback functionality back to Model #1. Since the processing approach indicated by the CSI prediction functionality for the last time is Model #4, and Model #4 and Model #1 are both contained in the second element in the switching sequence, the UE may determine that the target processing approach of the CSI prediction functionality is Model #4. The UE may not only switch the processing approach of the CSI feedback functionality to Model #1, but also switch the processing approach of the CSI prediction functionality to Model #4. Similarly, since the switching sequence does not contain {Model #1} and {Model #4}, that is, whenever any one of the CSI prediction functionality and the CSI feedback functionality applies the target processing approach prior to the other functionality, there will be a combination of processing approaches that is not in the switching sequence. Therefore, the UE applies Model #1 and Model #4 synchronously at the same time.

Thus, AI collision and/or compatibility problems between multiple functions may be avoided through the above processing.

In addition, the above method performed by the UE may, for example, further include: when the target processing approach is a combination of the processing approaches of the multiple functionalities, and a second condition is satisfied, starting to apply the processing approach of each functionality among the target processing approaches related to the multiple functionalities simultaneously from the second time. The second time is related to at least one of a switching delay, a first delay or an interruption time required when the multiple functionalities perform switching respectively, that is, related to at least one of a switching delay, a first delay or an interruption time required when each function performs switching separately without considering applying the target processing approaches related to the multiple functionalities simultaneously. The switching delay required when each functionality switches separately represents a time difference between a time at which the functionality applies the corresponding target processing approach (i.e., the time at which the switching indication information is received) and the first time. In other words, the switching delay required when each functionality switches separately represents how long after the first time the functionality starts to apply the corresponding target processing approach. The first delay required when each functionality switches separately represents a time difference between a time at which the functionality deactivates the corresponding source processing approach and the first time. In other words, the first delay required when each functionality switches separately represents how long after the first time the functionality deactivates the corresponding source processing approach. The interruption time required when each functionality switches separately represents a time difference between a time at which the functionality applies the corresponding target processing approach and a time at which the functionality deactivates the corresponding source processing approach. In other words, the interruption time required when each functionality switches separately represents how long after the time at which the functionality deactivates the corresponding source processing approach the functionality starts to apply the corresponding target processing approach. The second condition may, for example, include at least one of following items: the target processing approach is indicated by the position number of the element in the first switching sequence; a combination of processing approaches that is not included in the first switching sequence appears in the combinations of the processing approaches of the multiple functionalities, in the case in which multiple functionalities perform asynchronous processing approach switching.

Specifically, the second time T2ₘᵤₗₜᵢ may be determined according to following equations (8) and (9).

Tdₘᵤₗₜᵢ=max({Tdᵢ})+Δ₂ (8)

T2ₘᵤₗₜᵢ=T1+Tdₘᵤₗₜᵢ (9)

where Tdᵢ represents a switching delay required when the ith functionality related to the target processing approach performs switching separately, and the switching delay Tdᵢ may be determined by any method or combination of methods 1 to 4 described above; Δ₂ represents a processing time margin for synchronous switching of multiple functionalities, which may be preset, set by the BS, or determined according to the capability of the UE; i=1, 2, . . . N, where N represents the number of multiple functionalities.

For another example, the second time T2ₘᵤₗₜᵢ may be determined according to following equation (10) and above equation (9).

Tdₘᵤₗₜᵢ=max(T_{fb_multi}+max({Tinᵢ}),max({Tdᵢ}))+Δ₂ (10)

where, T_{fb}_{ₘᵤₗₜᵢ} represents the first delay when multiple functionalities perform switching simultaneously, that is, a time difference between the time at which multiple functionalities related to the target processing approach deactivate corresponding source processing approaches at the same time and the first time. T_{fb}_{ₘᵤₗₜᵢ} may be preset, set by the BS, or determined according to the capability of the UE, or determined according to equation (11) to be described below. Tini represents the interruption time when the ith functionality related to the target processing approach performs switching separately. Tdᵢ represents the switching delay required when the ith functionality related to the target processing approach performs switching separately.

The above method performed by the UE may, for example, further include: when the target processing approach is the combination of the processing approaches of multiple functionalities, and a third condition is satisfied, starting to deactivate the source processing approaches of the multiple functionalities simultaneously from the third time, wherein the third time is related to the first delay required when the multiple functionalities perform switching, respectively. The third condition includes, for example at least one of following items: the second condition is satisfied; and in the case in which the multiple functionalities deactivate the corresponding source processing approaches asynchronously, and each functionality adopts the corresponding first processing approach within the time between deactivating the corresponding source processing approach and applying the corresponding target processing approach, a combination of processing approaches that is not included in the first switching sequence appears in the combinations of the processing approaches of the multiple functionalities.

Specifically, for example, the third time T3ₘᵤₗₜᵢ may be determined according to following equations (11) and (12).

T_{fb_multi}=max({T_{fb_i}})+Δ₃ (11)

T3ₘᵤₗₜᵢ=T1+T_{fb_multi} (12)

where T_{fb_i} represents the first delay required when the ith functionality related to the target processing approach performs switching separately. Δ₃ represents a processing time margin for synchronous switching of multiple functionalities, which may be preset, set by the BS, or determined according to the capability of the UE.

In an example embodiment, when the target processing approach is related to multiple functionalities, if the target processing approach is indicated based on the position number of the element in the switching sequence, or if the switching indication information explicitly contains the indication of synchronous switching, the UE synchronously switches the processing approaches of the multiple functionalities, that is, applies the target processing approaches of the multiple functionalities simultaneously, and deactivates the source processing approaches of the multiple functionalities simultaneously.

In an example embodiment, the target processing approach is related to multiple functionalities. If these multiple functionalities apply the target processing approaches asynchronously, the combination of processing approaches that is not included in the first switching sequence will appear in the combinations of the processing approaches of these multiple functionalities during the period from the time of receiving the switching indication information to the time when the last functionality starts to apply its corresponding target processing approach. Then the UE applies the target processing approach simultaneously at the second time.

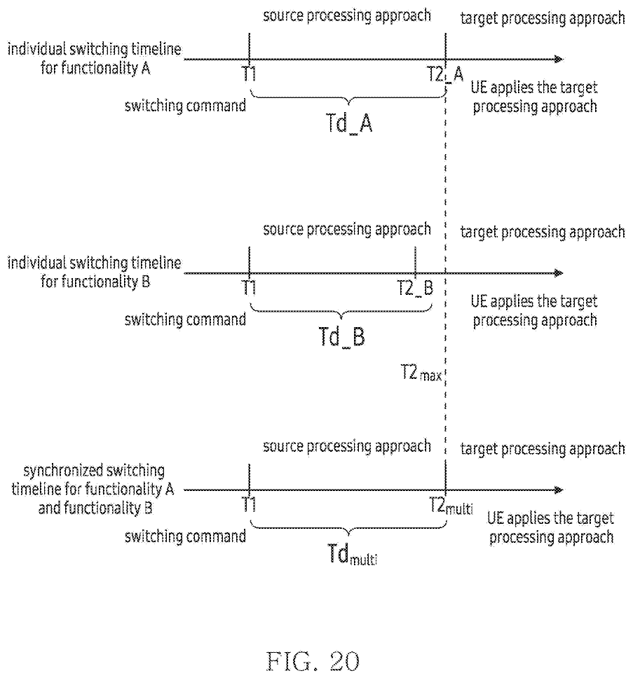

For example, as illustrated in FIGS. 19 and 20, the CSI feedback functionality (functionality A) and the CSI prediction functionality (functionality B) switch from {Model #1, Model #4} to {Model #2}. If these two functionalities switch independently (that is, applying the corresponding target processing approach asynchronously), since the time at which the CSI prediction functionality applies the corresponding target processing approach (that is, the non-AI processing approach) will be prior to the time at which the CSI feedback functionality applies Model #2, such a combination of processing approaches {Model #1} will appear for the two functionalities, that is, the CSI feedback functionality applies Model #1, and the CSI prediction functionality applies a non-AI processing approach. However, such a combination of processing approaches is not included in the first switching sequence. Therefore, referring to FIG. 20, according to the above equation (8), the UE applies the target processing approaches corresponding to these two functionalities simultaneously at the time of T2ₘᵤₗₜᵢ=max (T2_A, T2_B) under the assumption that only max({Tdᵢ}) and Δ₂=0 are considered, where T2_A is the switching delay required when the CSI feedback functionality switches separately, and T2_B is the switching delay required when the CSI prediction functionality switches separately.

In an example embodiment, the time for deactivating the target processing approaches by multiple functionalities may be further considered.

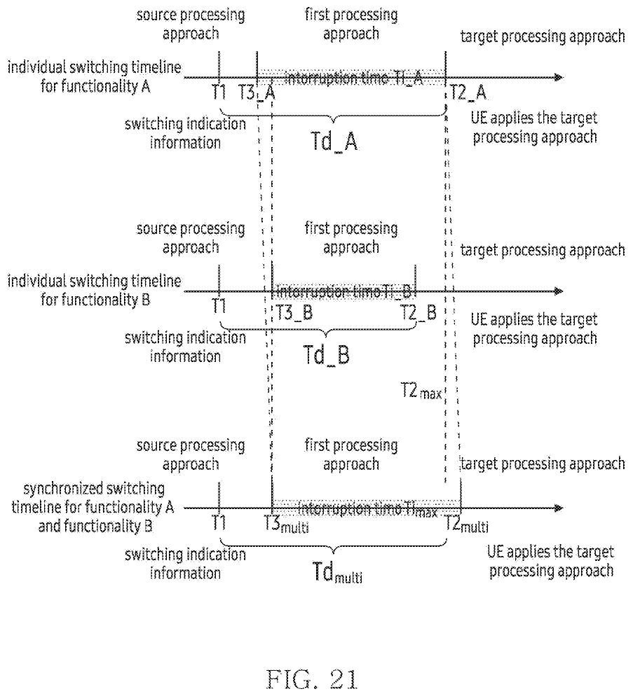

For example, supposing the switching sequence is {{Model #1, Model #2}, {Model #3, Model #4}, { }}, the UE performs the switching from the processing approach indicated by element 1 in the switching sequence to the processing approach indicated by element 2, that is, the functionality A switches from Model #1 to Model #3, and the functionality B switches from Model #2 to Model #4. It is assumed that there will be an interruption time when these two functionalities switch the processing approach (that is, deactivating the corresponding source processing approach first, and then applying the corresponding target processing approach), and both functionality A and functionality B adopt non-AI processing approaches within the interruption time. If these two functionalities deactivate the source processing approach and apply the corresponding first processing approach asynchronously, assuming that the first processing approaches of these two functionalities are non-AI processing approaches, and that functionality A deactivates Model #1 prior to functionality B deactivating Model #2, then there will be such a combination of processing approaches {Model #2} for functionalities A and B, that is, functionality A applies the non-AI processing approach, and functionality B applies Model #2. However, such the combination of processing approaches is not included in the switching sequence. Therefore, the UE simultaneously deactivates the source processing approaches (i.e., Model #1 and Model #2) corresponding to these two functionalities at time T3ₘᵤₗₜᵢ=T1+max(T3_A−T1, T3_B−Ti) (i.e., here corresponds to formulas (11) and (12) and Δ₃=0), as illustrated in FIG. 21.

Meanwhile, in this example, for functionality A, time T3ₘᵤₗₜᵢ is later than T3_A, that is, in order to synchronously deactivate the source processing approaches, functionality A delays the time of deactivating Model #1. In order to ensure that the UE has sufficient processing time, the longest interruption time (i.e., max({Tini})) is considered for T2ₘᵤₗₜᵢ, as illustrated in FIG. 21.

Thus, AI collision and/or compatibility problems generated between multiple functions in the switching process may be avoided through the above processing.

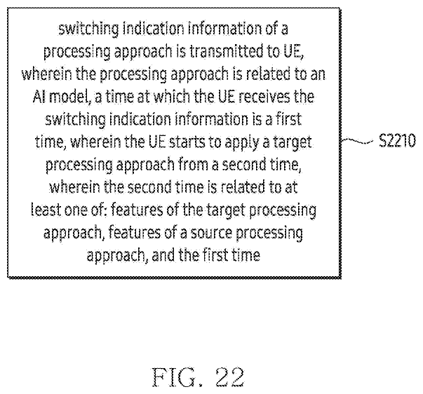

FIG. 22 is a flowchart illustrating an example method performed by a base station according to various embodiments.

As illustrated in FIG. 22, in step S2210, switching indication information of a processing approach is transmitted to the UE, wherein the processing approach is related to an AI model, a time at which the UE receives the switching indication information is a first time, wherein the UE starts to apply a target processing approach from a second time, wherein the second time is related to at least one of following items: features of the target processing approach, features of a source processing approach, or the first time.

In an example embodiment, the features of the target processing approach and/or the source processing approach include at least one of following items: a size of an AI model(s) related to the target processing approach and/or a size of an AI model(s) related to the source processing approach; the number of the AI model(s) related to the target processing approach and/or the number of the AI model(s) related to the source processing approach; whether the target processing approach belongs to a first set; whether the source processing approach belongs to a second set; a structure(s) of the AI model(s) related to the target processing approach and/or a structure(s) of the AI model(s) related to the source processing approach; a position(s) of the target processing approach and/or the source processing approach in a first switching sequence; or the number of a functionality(s) related to the target processing approach and/or the number of a functionality(s) related to the source processing approach.

In an example embodiment, the first set and/or the second set are/is indicated by a base station or preset.

In an example embodiment, the method further includes, for example, indicating a switching sequence to the UE and receiving a reported switching sequence from the UE.

In an example embodiment, the first switching sequence is associated with at least one of following items: a switching sequence indicated by the base station; a switching sequence reported by the UE; or a preset switching sequence.

In an example embodiment, the method further includes, for example, indicating a first processing approach to the UE, wherein when a first condition is satisfied, the UE deactivates the source processing approach at a third time, and applies the first processing approach between the third time to the second time.

In an example embodiment, the first condition includes at least one of following items: a size of an AI model(s) related to the source processing approach is not less than a first threshold and/or a size of an AI model(s) related to the target processing approach is not less than a second threshold; a sum of the size of the AI model(s) related to the source processing approach and/or the size of the AI model(s) related to the target processing approach is not less than a third threshold; a processing source of the UE already occupied at the first time is not less than a fourth threshold and/or the size of the AI model(s) related to the target processing approach is not less than a fifth threshold; the structure(s) of the AI model(s) related to the source processing approach is same as the structure(s) of the AI model(s) related to the target processing approach; a related performance parameter value of the source processing approach is not greater than a sixth threshold; and a difference value between the second time and the first time is not less than a seventh threshold.

In an example embodiment, the third time is related to at least one of following items: features of the first processing approach, the features of the source processing approach, or the first time.

In an example embodiment, the features of the first processing approach include at least one of following items: a size of an AI model(s) related to the first processing approach; the number of the AI model(s) related to the first processing approach; whether the first processing approach belongs to a first set; a structure(s) of the AI model(s) related to the first processing approach; a position of the first processing approach in a first switching sequence; or the number of a functionality(s) related to the first processing approach.

In an example embodiment, the first switching sequence includes different processing approaches of one functionality, each element in the first switching sequence includes a processing approach of the functionality, and in the first switching sequence, an AI model-based processing approach is represented by a model ID of an AI model, a model ID combination or a configuration ID, and a non-AI processing approach is represented by an empty set or a configuration ID of a non-AI approach.

In an example embodiment, the first switching sequence includes different processing approaches of multiple functionalities, wherein each element in the first switching sequence includes a combination of the processing approaches of the multiple functionalities, wherein in the first switching sequence, an AI model-based processing approach is represented by a model ID of an AI model, a model ID combination or a configuration ID, a non-AI processing approach is represented by an empty set or a configuration ID of a non-AI approach, and the empty set represents that the multiple functionalities use the non-AI processing approaches, respectively. When an element in the first switching sequence does not contain the model ID related to one of the multiple functionalities, the processing approach of the one functionality included in the element is a processing approach of a non-AI approach.

In an example embodiment, each element in the first switching sequence further includes a switching condition related to the processing approach indicated by the element.

In an example embodiment, a sorted order of the elements in the first switching sequence is determined by at least one of following items: an order indicated by a base station; a preset order; or features of a processing approach.

In an example embodiment, the features of the processing approach include at least one of following items: a size of an AI model(s) related to the processing approach; the number of AI model(s) related to the processing approach; a complexity of the AI model(s) related to the processing approach; or an applicable condition of the processing approach, wherein the applicable condition of the processing approach includes at least one of following items: a cell range, an SNR range, a moving speed, a Doppler spread range, or a delay spread range.

In an example embodiment, a position(s) of the target processing approach and/or the source processing approach in the first switching sequence satisfy/satisfies at least one of following items: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy switching conditions and are adjacent to the source processing approach in the first switching sequence; the target processing approach is one of first N5 processing approaches in the first switching sequence; the target processing approach is one of first N6 processing approaches that satisfy switching conditions in the first switching sequence; the target processing approach is one of N7 processing approaches selected to be reported by the UE from the first switching sequence, wherein at least one of N1 to N7 is preset, set by the BS, determined according to the capability of the UE, or is the number related to the size of the AI model.

Since the related content has been described in detail above with reference to FIGS. 14A to 21, it will not be repeated here again.

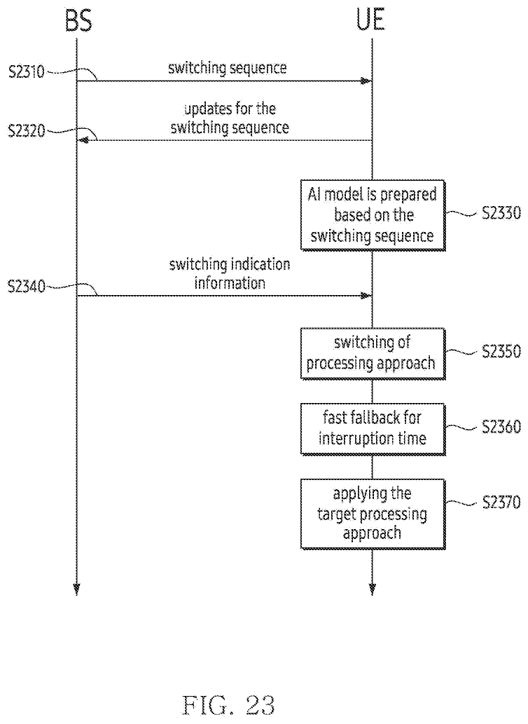

FIG. 23 is a signal flowchart illustrating an example of switching processing approaches related to an AI model according to various embodiments.

As illustrated in FIG. 23, in step S2310, a UE receives a switching sequence from the BS. As described above, the switching sequence received from the BS (i.e., the switching sequence indicated by the BS) may include multiple elements, each element may include a processing approach of one functionality, or a combination of processing approaches of multiple functionalities. Details will not be repeated here again since the details have been described in detail above. The switching sequence may provide necessary information for fast switching.

In step S2320, the UE reports the update for the switching sequence or the subset of the switching sequence to the BS, which is conducive to quickly adjusting the dynamic capability of the UE and avoiding AI collision. The UE may determine the first switching sequence according to the reported update for the switching sequence or the reported subset of the switching sequence. Since the first switching sequence has been described in detail above, the details will not be repeated here.

In step S2330, the UE may prepare the target processing approach in advance according to the first switching sequence. For example, the UE may prepare the target AI model in advance and load it into the memory in advance. This may be conducive to reducing the switching delay.

In step S2340, the UE receives switching indication information from the BS.

In step S2350, the UE determines the target processing approaches of multiple functionalities according to the first switching sequence, and performs the switching for the target processing approaches of the multiple functionalities, which may achieve the switching coordination of the processing approaches for multiple functionalities, and avoid AI collision or compatibility problems.

In step S2360, the UE executes the fallback method for the interruption time, that is, deactivates the source processing approach at the third time, applies the first processing approach within the interruption time (that is, between the third time and the second time), and then applies the target processing approach at the end of the interruption time (that is, at the second time), so as to realize the fast switching of the processing approaches for the interruption time.

In step S2370, the UE applies the target processing approach, that is, applies the target processing approach at the end of the interruption time, which may reduce the switching delay.

The signal flow described above with reference to FIG. 23 is only an example. Some of the steps S2310 to S2370 are optional. For example, when switching the processing approach for one functionality instead of switching the processing approaches for multiple functionalities, the step S2350 may be omitted.

Since the details involved therein have been described above with reference to FIGS. 14Aa to 21, they will not be repeated here again.

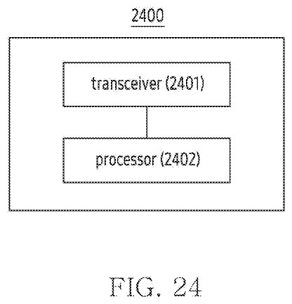

FIG. 24 is a block diagram illustrating an example model transmitter apparatus 2400 according to various embodiment.

Referring to FIG. 24, a model transmitter apparatus 2400 may include a transceiver 2401 and at least one processor 2402. Specifically, the at least one processor 2402 (including, e.g., processing circuitry) may be coupled to the transceiver 2401 and configured to perform the transmission method of the AI model mentioned in the above description related to FIG. 5. For the details of the operations involved in the transmission method of the AI model, reference can be made to the description of FIG. 5, which will not be repeated here.

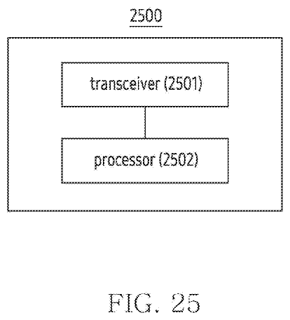

FIG. 25 is a block diagram illustrating an example model receiver apparatus 2500 according to various embodiments.

Referring to FIG. 25, the model receiver apparatus 2500 may include a transceiver 2501 and at least one processor 2502. Specifically, the at least one processor 2502 (including, e.g., processing circuitry) may be coupled to the transceiver 2501 and configured to perform the reception method of the AI model mentioned in the above description related to FIG. 8. For the details of the operations involved in the reception method of the AI model as described above, reference can be made to the description of FIG. 8, which will not be repeated here.

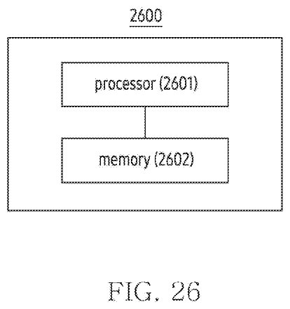

FIG. 26 is a block diagram illustrating an example electronic apparatus 2600 according to various embodiments.

Referring to FIG. 26, the electronic apparatus 2600 includes at least one processor 2601 (including, e.g., processing circuitry), and at least one memory 2602 storing computer executable instructions, wherein the computer executable instructions, when executed by the at least one processor 2601, cause the at least one processor 2601 to execute any one of the above-described methods.

According to an embodiment, a user equipment may also be provided, including a transceiver, and at least one processor, which is coupled with the transceiver and configured to execute the methods executed by the UE as described above.

According to an embodiment, a base station may also be provided, including a transceiver, and at least one processor, which is coupled with the transceiver and configured to execute the methods executed by the base station as described above.

At least one of the above plurality of modules may be implemented through an AI model. Functions associated with AI may be performed using a non-volatile memory, a volatile memory and a processor.

The processor may include one or more processors. The one or more processors may be general-purpose processors, such as central processing units (CPUs), application processors (APs), etc., processors only for graphics (such as graphics processors (GPUs), visual processors (VPUs), and/or AI dedicated processors (such as neural processing units (NPUs)).

One or more processors control the processing of input data according to predefined operation rules or artificial intelligence (AI) models stored in non-volatile memory and/or volatile memory. The predefined operation rules or AI models may be provided through training or learning. Here, providing by learning refers, for example, to applying learning algorithms to multiple learning data to form predefined operation rules or AI models with desired features. The learning may be performed in the device itself that executes AI according to the embodiment, and/or may be implemented by a separate server/device/system.

A learning algorithm is, for example, a method that uses multiple learning data to train a predetermined target device (for example, a robot) to make, allow or control the target device to make a determination or prediction. Examples of learning algorithms include but are not limited to supervised learning, unsupervised learning, semi-supervised learning or reinforcement learning.

AI models may be obtained through training. Here, “obtained through training” refers, for example, to training a basic AI model with multiple training data through a training algorithm to obtain predefined operation rules or AI models, which are configured to perform the required features (or purposes).

As an example, the artificial intelligence model may include multiple neural network layers. Each of the multiple neural network layers may include a plurality of weight values, and a neural network calculation is performed by performing a calculation between the calculation results of the previous layer and the multiple weight values. Examples of neural networks include, but are not limited to, convolutional neural networks (CNNs), deep neural networks (DNNs), recursive neural networks (RNNs), restricted Boltzmann machines (RBMs), deep confidence networks (DBNs), bidirectional recursive deep neural networks (BRDNNs), generative confrontation networks (GANs) and deep Q networks.

According to embodiments, a method executed by a user equipment (UE), comprises receiving, from a base station, switching indication information of a processing approach, wherein the processing approach is related to an artificial intelligence (AI) model, a time for receiving the switching indication information is a first time. The method comprises applying a target processing approach from a second time, wherein the second time is related to at least one of following items: features of the target processing approach, features of a source processing approach, and the first time.

In an embodiment, the features of the target processing approach and/or the source processing approach include at least one of following items: a size of an AI model(s) related to the target processing approach and/or a size of an AI model(s) related to the source processing approach; the number of the AI model(s) related to the target processing approach and/or the number of the AI model(s) related to the source processing approach; whether the target processing approach belongs to a first set; whether the source processing approach belongs to a second set; a structure(s) of the AI model(s) related to the target processing approach and/or a structure(s) of the AI model(s) related to the source processing approach; a position(s) of the target processing approach and/or the source processing approach in a first switching sequence; and the number of a functionality(s) related to the target processing approach and/or the number of a functionality(s) related to the source processing approach.

In an embodiment, the first set and/or the second set are/is indicated by a base station or preset.

In an embodiment, the first switching sequence is associated with at least one of following items: a switching sequence indicated by a base station; a switching sequence reported by the UE; and a preset switching sequence.

In an embodiment, the method comprises deactivating the source processing approach at a third time when a first condition is satisfied, wherein the third time is before the second time.

In an embodiment, the method comprises applying a first processing approach between the third time and the second time.

In an embodiment, the first condition comprises at least one of following items: a size of an AI model(s) related to the source processing approach is not less than a first threshold and/or a size of an AI model(s) related to the target processing approach is not less than a second threshold; a sum of the size of the AI model(s) related to the source processing approach and/or the size of the AI model(s) related to the target processing approach is not less than a third threshold; a processing source of the UE already occupied at the first time is not less than a fourth threshold and/or the size of the AI model(s) related to the target processing approach is not less than a fifth threshold; the structure(s) of the AI model(s) related to the source processing approach is same as the structure(s) of the AI model(s) related to the target processing approach; a related performance parameter value of the source processing approach is not greater than a sixth threshold; and a difference value between the second time and the first time is not less than a seventh threshold.

In an embodiment, the third time is related to at least one of following items: features of the first processing approach, the features of the source processing approach, and the first time.

In an embodiment, the features of the first processing approach comprise at least one of following items: a size of an AI model(s) related to the first processing approach; the number of the AI model(s) related to the first processing approach; whether the first processing approach belongs to a first set; a structure(s) of the AI model(s) related to the first processing approach; a position of the first processing approach in a first switching sequence; and the number of a functionality(s) related to the first processing approach.

In an embodiment, the method comprises determining the target processing approach related to multiple functionalities, wherein the target processing approach is a combination of processing approaches of the multiple functionalities. The target processing approach is related to at least one of following items: the switching indication information, and the first switching sequence.

In an embodiment, the position(s) of the target processing approach and/or the source processing approach in the first switching sequence satisfy/satisfies at least one of following items: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy the switching conditions and are adjacent to the source processing approach in the first switching sequence; the target processing approach is one of first N5 processing approaches in the first switching sequence; the target processing approach is one of first N6 processing approaches that satisfy the switching conditions in the first switching sequence; and the target processing approach is one of N7 processing approaches selected to be reported by the UE from the first switching sequence. At least one of N1 to N7 is preset, or is the number related to the size of the AI model.

According to embodiments, a method performed by a base station, comprises transmitting, to a UE, switching indication information of a processing approach, wherein the processing approach is related to an AI model, a time at which the UE receives the switching indication information is a first time. The UE starts to apply a target processing approach from a second time, wherein the second time is related to at least one of following items: features of the target processing approach, features of a source processing approach, and the first time.

According to embodiments, a user equipment, comprises a transceiver. The UE comprises at least one processor coupled to the transceiver and configured to execute the methods.

According to embodiments, a base station comprises a transceiver. The base station comprises at least one processor coupled to the transceiver and configured to execute the methods.

According to embodiments, a computer readable storage medium storing instructions, wherein the instructions, when executed by at least one processor, cause the at least one processor to execute the methods.

According to embodiments, a method performed by a user equipment (UE) comprises receiving, from a base station, switching indication information for switching from a source processing approach to a target processing approach, wherein the source processing approach or the target processing approach are related to an artificial intelligence (AI) model. The method comprises applying the target processing approach from a second time. The second time is identified based on at least one of features of the target processing approach, features of the source processing approach, or a first time. The first time is a time in which the switching indication information is received.

In an embodiment, the features of the target processing approach and the source processing approach include at least one of: a size of at least one AI model related to the target processing approach or a size of at least one AI model related to the source processing approach; a number of the at least one AI model related to the target processing approach or a number of the at least one AI model related to the source processing approach; whether the target processing approach belongs to a first set; whether the source processing approach belongs to a second set; a structure of the at least one AI model related to the target processing approach or a structure of the least one AI model related to the source processing approach; a position of the target processing approach or the source processing approach in a first switching sequence; or a number of a functionality related to the target processing approach or a number of a functionality related to the source processing approach.

In an embodiment, the first set is indicated by the base station or preset, and the second set is indicated by the base station or preset.

In an embodiment, the first switching sequence is associated with at least one of following: a switching sequence indicated by the base station; a switching sequence reported by the UE; or a preset switching sequence.

In an embodiment, the method comprises deactivating the source processing approach at a third time when a first condition is satisfied, wherein the third time is before the second time. The method comprises applying a first processing approach between the third time and the second time.

In an embodiment, the first condition comprises at least one of: a size of at least one AI model related to the source processing approach is not less than a first threshold and/or a size of at least one AI model related to the target processing approach is not less than a second threshold; a sum of the size of the at least one AI model related to the source processing approach or the size of the at least one AI model related to the target processing approach is not less than a third threshold; a processing source of the UE already occupied at the first time is not less than a fourth threshold and/or the size of the at least one AI model related to the target processing approach is not less than a fifth threshold; a structure of the at least one AI model related to the source processing approach is same as a structure of the at least one AI model related to the target processing approach; a related performance parameter value of the source processing approach is not greater than a sixth threshold; or a difference value between the second time and the first time is not less than a seventh threshold.

In an embodiment, the third time is related to at least one of features of the first processing approach, the features of the source processing approach, or the first time.

In an embodiment, wherein the features of the first processing approach comprise at least one of: a size of at least one AI model related to the first processing approach; a number of the at least one AI model related to the first processing approach; whether the first processing approach belongs to a first set; a structure of the least one AI model related to the first processing approach; a position of the first processing approach in a first switching sequence; or a number of a functionality related to the first processing approach.

In an embodiment, the method comprises determining the target processing approach related to multiple functionalities, wherein the target processing approach is a combination of processing approaches of the multiple functionalities. The target processing approach is related to at least one of following the switching indication information, or the first switching sequence.

In an embodiment, the position of the target processing approach and the source processing approach in the first switching sequence satisfy at least one of: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy the switching conditions and are adjacent to the source processing approach in the first switching sequence; the target processing approach is one of first N5 processing approaches in the first switching sequence; the target processing approach is one of first N6 processing approaches that satisfy the switching conditions in the first switching sequence; or the target processing approach is one of N7 processing approaches selected to be reported by the UE from the first switching sequence, wherein at least one of N1 to N7 is preset, or is a number related to the size of the at least one AI model.

According to embodiments, a user equipment (UE) comprises a transceiver. The UE comprises a processor coupled to the transceiver. The processor is configured to receive, from a base station, switching indication information for switching from a source processing approach to a target processing approach, wherein the source processing approach or the target processing approach are related to an artificial intelligence (AI) model. The processor is configured to apply the target processing approach from a second time, wherein the second time is identified based on at least one of features of the target processing approach, features of the source processing approach, or the first time. wherein a first time is a time in which the switching indication information is received.

In an embodiment, the features of the target processing approach and the source processing approach include at least one of: a size of at least one AI model related to the target processing approach or a size of at least one AI model related to the source processing approach; a number of the at least one AI model related to the target processing approach or a number of the at least one AI model related to the source processing approach; whether the target processing approach belongs to a first set; whether the source processing approach belongs to a second set; a structure of the at least one AI model related to the target processing approach or a structure of the least one AI model related to the source processing approach; a position of the target processing approach or the source processing approach in a first switching sequence; or a number of a functionality related to the target processing approach or a number of a functionality related to the source processing approach.

In an embodiment, the first set is indicated by the base station or preset, and the second set is indicated by the base station or preset.

In an embodiment, the first switching sequence is associated with at least one of following: a switching sequence indicated by the base station; a switching sequence reported by the UE; or a preset switching sequence

In an embodiment, the processor is configured to deactivate the source processing approach at a third time when a first condition is satisfied, wherein the third time is before the second time. The processor is configured to apply a first processing approach between the third time and the second time.

In an embodiment, the first condition comprises at least one of: a size of at least one AI model related to the source processing approach is not less than a first threshold and/or a size of at least one AI model related to the target processing approach is not less than a second threshold; a sum of the size of the at least one AI model related to the source processing approach or the size of the at least one AI model related to the target processing approach is not less than a third threshold; a processing source of the UE already occupied at the first time is not less than a fourth threshold and/or the size of the at least one AI model related to the target processing approach is not less than a fifth threshold; a structure of the at least one AI model related to the source processing approach is same as a structure of the at least one AI model related to the target processing approach; a related performance parameter value of the source processing approach is not greater than a sixth threshold; or a difference value between the second time and the first time is not less than a seventh threshold.

In an embodiment, the third time is related to at least one of features of the first processing approach, the features of the source processing approach, or the first time.

In an embodiment, wherein the features of the first processing approach comprise at least one of: a size of at least one AI model related to the first processing approach; a number of the at least one AI model related to the first processing approach; whether the first processing approach belongs to a first set; a structure of the least one AI model related to the first processing approach; a position of the first processing approach in a first switching sequence; or a number of a functionality related to the first processing approach.

In an embodiment, the processor is configured to determine the target processing approach related to multiple functionalities, wherein the target processing approach is a combination of processing approaches of the multiple functionalities. The target processing approach is related to at least one of following the switching indication information, or the first switching sequence.

In an embodiment, the position of the target processing approach and the source processing approach in the first switching sequence satisfy at least one of: the target processing approach is one of N1 processing approaches located after the source processing approach in the first switching sequence; the target processing approach is one of N2 processing approaches that satisfy switching conditions and are located after the source processing approach in the first switching sequence; the target processing approach is one of N3 processing approaches adjacent to the source processing approach in the first switching sequence; the target processing approach is one of N4 processing approaches that satisfy the switching conditions and are adjacent to the source processing approach in the first switching sequence; the target processing approach is one of first N5 processing approaches in the first switching sequence; the target processing approach is one of first N6 processing approaches that satisfy the switching conditions in the first switching sequence; or the target processing approach is one of N7 processing approaches selected to be reported by the UE from the first switching sequence, wherein at least one of N1 to N7 is preset, or is a number related to the size of the at least one AI model.

According to embodiments, a method performed by a base station, comprises transmitting, to a UE, switching indication information for switching from a source processing approach to a target processing approach, wherein the source processing approach or the target processing approach are related to an AI model. The target processing approach is applied by the UE from a second time. A first time is a time in which the switching indication information is received. The second time is related to at least one of features of the target processing approach, features of the source processing approach, or the first time.

According to example embodiments, a computer readable storage medium storing instructions may be provided, wherein the instructions, when being executed by at least one processor, cause the at least one processor to execute the above various methods according to the example embodiments of the present disclosure. Examples of the computer-readable storage medium include, for example Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as, multimedia cards, secure digital (SD) cards or extreme speed digital (XD) cards), magnetic tapes, floppy disks, magneto-optical data storage device, optical data storage device, hard disk, solid state disk, and any other devices that are configured to store computer programs and any associated data, data files and data structures in a non-transitory manner, and provide the computer programs and any associated data, data files and data structures to the processor or computer, so that the processor or computer may execute the computer programs. The instructions or computer programs in the above-mentioned computer-readable storage mediums may run in an environment deployed in a computer apparatus such as a client, a host, an agent device, a server, or the like. In addition, in an example, the computer programs and any associated data, data files and data structures may be distributed on networked computer systems, so that the computer programs and any associated data, data files and data structures may be stored, accessed, and executed in a distributed manner through one or more processors or computers.

Those skilled in the art will easily conceive of other implementation solutions of the present disclosure after considering the description and practicing the example embodiments disclosed herein. The present application is intended to cover any modifications, uses, or adaptive changes of the present disclosure. These modifications, uses, or adaptive changes follow the general principles of the present disclosure and include common knowledge or customary technical means in the technical field that are not disclosed by the present disclosure. The description and the embodiments are only regarded as examples, and the true scope and spirit of the present disclosure are defined by the claims.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method executed by a user equipment (UE), the method comprising:
receiving, from a base station, switching indication information for switching from a source processing approach to a target processing approach, wherein the source processing approach or the target processing approach are related to an artificial intelligence (AI) model; and
applying the target processing approach from a second time, wherein the second time is identified based on at least one of features of the target processing approach, features of the source processing approach, or a first time,
wherein the first time is a time in which the switching indication information is received.

2. The method of claim 1, wherein the features of the target processing approach and the source processing approach include at least one of:
a size of at least one AI model related to the target processing approach or a size of at least one AI model related to the source processing approach;
a number of the at least one AI model related to the target processing approach or a number of the at least one AI model related to the source processing approach;
whether the target processing approach belongs to a first set;
whether the source processing approach belongs to a second set;
a structure of the at least one AI model related to the target processing approach or a structure of the least one AI model related to the source processing approach;
a position of the target processing approach or the source processing approach in a first switching sequence; or
a number of a functionality related to the target processing approach or a number of a functionality related to the source processing approach.

3. The method of claim 2, wherein the first set is indicated by the base station or preset, and
wherein the second set is indicated by the base station or preset.

4. The method of claim 2, wherein the first switching sequence is associated with at least one of:
a switching sequence indicated by the base station;
a switching sequence reported by the UE; or
a preset switching sequence.

5. The method of claim 1, further comprising:
deactivating the source processing approach at a third time when a first condition is satisfied, wherein the third time is before the second time, and
applying a first processing approach between the third time and the second time.

6. The method of claim 5, wherein the first condition comprises at least one of:
a size of at least one AI model related to the source processing approach is not less than a first threshold and/or a size of at least one AI model related to the target processing approach is not less than a second threshold;
a sum of the size of the at least one AI model related to the source processing approach or the size of the at least one AI model related to the target processing approach is not less than a third threshold;
a processing source of the UE already occupied at the first time is not less than a fourth threshold and/or the size of the at least one AI model related to the target processing approach is not less than a fifth threshold;
a structure of the at least one AI model related to the source processing approach is same as a structure of the at least one AI model related to the target processing approach;
a related performance parameter value of the source processing approach is not greater than a sixth threshold; or
a difference value between the second time and the first time is not less than a seventh threshold.

7. The method of claim 5, wherein the third time is related to at least one of features of the first processing approach, the features of the source processing approach, or the first time.

8. The method of claim 7, wherein the features of the first processing approach comprise at least one of:
a size of at least one AI model related to the first processing approach;
a number of the at least one AI model related to the first processing approach;
whether the first processing approach belongs to a first set;
a structure of the least one AI model related to the first processing approach;
a position of the first processing approach in a first switching sequence; or
a number of a functionality related to the first processing approach.

9. The method of claim 1, further comprising:
determining the target processing approach related to multiple functionalities, wherein the target processing approach is a combination of processing approaches of the multiple functionalities,
wherein the target processing approach is related to at least one of following the switching indication information, or the first switching sequence.

10. The method of claim 2, wherein the position of the target processing approach and the source processing approach in the first switching sequence satisfy at least one of:
the target processing approach is one of N1 processing approaches located after the source processing approach in the first switching sequence;
the target processing approach is one of N2 processing approaches that satisfy switching conditions and are located after the source processing approach in the first switching sequence;
the target processing approach is one of N3 processing approaches adjacent to the source processing approach in the first switching sequence;
the target processing approach is one of N4 processing approaches that satisfy the switching conditions and are adjacent to the source processing approach in the first switching sequence;
the target processing approach is one of first N5 processing approaches in the first switching sequence;
the target processing approach is one of first N6 processing approaches that satisfy the switching conditions in the first switching sequence; or
the target processing approach is one of N7 processing approaches selected to be reported by the UE from the first switching sequence,
wherein at least one of N1 to N7 is preset, or is a number related to the size of the at least one AI model.

11. A user equipment (UE) comprising:
a transceiver; and
a processor coupled to the transceiver,
wherein the processor is configured to:
receive, from a base station, switching indication information for switching from a source processing approach to a target processing approach, wherein the source processing approach or the target processing approach are related to an artificial intelligence (AI) model; and
apply the target processing approach from a second time, wherein the second time is identified based on at least one of features of the target processing approach, features of the source processing approach, or a first time,
wherein the first time is a time in which the switching indication information is received.

12. The UE of claim 11, wherein the features of the target processing approach and the source processing approach include at least one of:
a size of at least one AI model related to the target processing approach or a size of at least one AI model related to the source processing approach;
a number of the at least one AI model related to the target processing approach or a number of the at least one AI model related to the source processing approach;
whether the target processing approach belongs to a first set;
whether the source processing approach belongs to a second set;
a structure of the at least one AI model related to the target processing approach or a structure of the least one AI model related to the source processing approach;
a position of the target processing approach or the source processing approach in a first switching sequence; or
a number of a functionality related to the target processing approach or a number of a functionality related to the source processing approach.

13. The UE of claim 12, wherein the first set is indicated by the base station or preset, wherein the second set is indicated by the base station or preset, and
wherein the first switching sequence is associated with at least one of following:
a switching sequence indicated by the base station;
a switching sequence reported by the UE; or
a preset switching sequence.

14. The UE of claim 11, wherein the processor is further configured to:
deactivate the source processing approach at a third time when a first condition is satisfied, wherein the third time is before the second time, and
apply a first processing approach between the third time and the second time.

15. The UE of claim 14, wherein the first condition comprises at least one of:
a size of at least one AI model related to the source processing approach is not less than a first threshold or a size of at least one AI model related to the target processing approach is not less than a second threshold;
a sum of the size of the at least one AI model related to the source processing approach or the size of the at least one AI model related to the target processing approach is not less than a third threshold;
a processing source of the UE already occupied at the first time is not less than a fourth threshold or the size of the at least one AI model related to the target processing approach is not less than a fifth threshold;
a structure of the at least one AI model related to the source processing approach is same as a structure of the at least one AI model related to the target processing approach;
a related performance parameter value of the source processing approach is not greater than a sixth threshold; or
a difference value between the second time and the first time is not less than a seventh threshold.

16. The UE of claim 14, wherein the third time is related to at least one of features of the first processing approach, the features of the source processing approach, or the first time.

17. The UE of claim 16, wherein the features of the first processing approach comprise at least one of:
a size of at least one AI model related to the first processing approach;
a number of the at least one AI model related to the first processing approach;
whether the first processing approach belongs to a first set;
a structure of the least one AI model related to the first processing approach;
a position of the first processing approach in a first switching sequence; or
a number of a functionality related to the first processing approach.

18. The UE of claim 11, wherein the processor is further configured to:
determine the target processing approach related to multiple functionalities, wherein the target processing approach is a combination of processing approaches of the multiple functionalities,
wherein the target processing approach is related to at least one of following the switching indication information, or the first switching sequence.

19. The UE of claim 12, wherein the position of the target processing approach and the source processing approach in the first switching sequence satisfy at least one of:
the target processing approach is one of N1 processing approaches located after the source processing approach in the first switching sequence;
the target processing approach is one of N2 processing approaches that satisfy switching conditions and are located after the source processing approach in the first switching sequence;
the target processing approach is one of N3 processing approaches adjacent to the source processing approach in the first switching sequence;
the target processing approach is one of N4 processing approaches that satisfy the switching conditions and are adjacent to the source processing approach in the first switching sequence;
the target processing approach is one of first N5 processing approaches in the first switching sequence;
the target processing approach is one of first N6 processing approaches that satisfy the switching conditions in the first switching sequence; or
the target processing approach is one of N7 processing approaches selected to be reported by the UE from the first switching sequence,
wherein at least one of N1 to N7 is preset, or is a number related to the size of the at least one AI model.

20. A method performed by a base station, the method comprising:
transmitting, to a UE, switching indication information for switching from a source processing approach to a target processing approach, wherein the source processing approach or the target processing approach are related to an AI model,
wherein the target processing approach is applied by the UE from a second time,
wherein a first time is a time in which the switching indication information is received, and
wherein the second time is related to at least one of features of the target processing approach, features of the source processing approach, or the first time.
